(19) United States
(12) Patent Application Publication
(10) Pub. No.: US 2026/0314900 A1
(43) Pub. Date: Oct. 15, 2026

(54) MOP SYSTEM

(71) Applicant: United Industries Corporation, Earth City, MO (US)

(72) Inventors: Bradley Turner, Earth City, MO (US); Gregory Wilsey, Earth City, MO (US); Alex Wall, Earth City, MO (US); Stephen P. Dechant, Earth City, MO (US)

(21) Appl. No.: 19/466,750

(22) Filed: Feb. 2, 2026

Related U.S. Application Data
(60) Provisional application No. 63/765,005, filed on Feb. 28, 2025.

(51) Int. Cl. A47L 13/22; A47L 13/254; F04B 9/14

(52) U.S. Cl. CPC A47L 13/22; A47L 13/254; F04B 9/14

(57) ABSTRACT

A mop includes a handle, a support assembly, a bottle seat assembly, and a mop head. The support assembly is connected to the handle. The bottle seat assembly is mounted to the support assembly and configured to receive a bottle assembly. The bottle seat assembly includes a liquid reservoir and a plurality of nozzles fluidically connected to the liquid reservoir. The liquid reservoir includes a first chamber, a second chamber, a first fluid pathway, a bottle interface, and a plurality of nozzles. The first chamber is configured to receive liquid from the bottle assembly. The second chamber is fluidically connected to the first chamber. The first fluid pathway extends between the first chamber and the second chamber. The first fluid pathway has an inlet positioned within the first chamber. The bottle interface defines an air outlet opening, where the air outlet opening is positioned above the first fluid pathway.

### CROSS-REFERENCE TO RELATED APPLICATION(S)

This application claims the benefit of U.S. Provisional Application Ser. No. 63/765005, filed Feb. 28, 2025, the disclosure of which is hereby incorporated by reference in its entirety.

### BACKGROUND

Floor cleaning systems that have an onboard cleaning fluid are used in residential applications as a convenient alternative to traditional hand cleaning of floors with a bucket and rag. Floor cleaning systems include various features for convenience, handling, and functionality. Continued improvements are needed.

### SUMMARY

In general terms, this disclosure is related to an improved flat mop for removing dirt and soil from floors.

In some embodiments, and by non-limiting example, the present disclosure relates to a mop having a handle with a trigger, a support assembly connected to the handle, a bottle seat assembly connected to the support assembly, a mop head connected to the bottle seat assembly via a joint, and a mop pad removably attached to the mop head.

In some embodiments, and by non-limiting example, the present disclosure relates to an improved mop head that includes cutout sides for receiving a tab located on a mop pad. The tab facilitates the removal of the mop pad from the mop head without having to touch the dirty part of the mop pad after it has been used to clean a floor.

In some embodiments, and by non-limiting example, the present disclosure relates to an improved mop head that includes a flexible scrubber portion for selectively engaging the floor when needed to remove difficult-to-clean soils.

In some embodiments, and by non-limiting example, the present disclosure relates to a mop pad that has a tab positioned along one side of the mop pad. In another embodiment, the present disclosure relates to a mop pad that has a flexible scrubber portion in the center of the mop pad that can be selectively engaged for cleaning difficult-to-clean soils.

In some embodiments, and by non-limiting example, the present disclosure relates to a modular support system for assembling a support assembly for a mop.

In some embodiments, and by non-limiting example, the present disclosure relates to a mop that includes a handle, a support assembly, a bottle seat assembly, and a mop head. The support assembly is connected to the handle. The bottle seat assembly is mounted to the support assembly and configured to receive a bottle assembly. The bottle seat assembly includes a liquid reservoir and a plurality of nozzles fluidically connected to the liquid reservoir. The liquid reservoir includes a first chamber, a second chamber, a first fluid pathway, a bottle interface, and a plurality of nozzles. The first chamber is configured to receive liquid from the bottle assembly. The second chamber is fluidically connected to the first chamber. The first fluid pathway extends between the first chamber and the second chamber. The first fluid pathway has an inlet positioned within the first chamber. The bottle interface defines an air outlet opening which positioned above the first fluid pathway.

In some embodiments, and by non-limiting example, the present disclosure relates to a mop that includes a handle, a support assembly, a mop head, and a bottle seat assembly. The support assembly is connected to the handle. The mop head defines a top surface. The top surface defines a bottle seat engagement region that is centrally positioned on the top surface. The bottle seat engagement region includes two pin cavities, a storage channel, a storage ridge, and a locking cavity adjacent each pin cavity. The storage ridge is positioned at a base of the storage channel. The bottle seat assembly is mounted to the support assembly and mounted to the mop head. The bottle seat assembly includes a joint connecting the bottle seat assembly to a mop head. The joint includes an upper portion and a lower portion. The upper portion defines a post that extends outward from the upper portion and defines a post axis. The upper portion defines a rear face with a storage pocket. The lower portion pivotably connects to the post. The lower portion is rotatable about the post axis. The lower portion includes two pins that extend laterally from opposite sides and define a pin axis normal to the post axis. The lower portion defines a locking protrusion adjacent each pin. In a storage position, the mop head is rotated such that the locking protrusions engage the locking cavities to prevent rotation about the pin axis, and the storage ridge engages the storage pocket to prevent rotation about the post axis.

In some embodiments, and by non-limiting example, the present disclosure relates to a mop that includes a handle, a support assembly, and a bottle seat assembly. The support assembly is connected to the handle. The bottle seat assembly is mounted to the support assembly and configured to receive a bottle assembly. The bottle seat assembly includes a liquid reservoir, first and second nozzles, and a switch. The liquid reservoir is configured to receive liquid from a bottle assembly. The first and second nozzles are both fluidically connected to the liquid reservoir. Each of the first and second nozzles include a seal that is movable between an open state and a sealed state. The seal is biased toward the open state. The first and second nozzles define a toggle portion. The switch is accessible by a user. The switch controls a cam. The cam is movable between the first nozzle and the second nozzle. The cam engages the toggle portion of both the first and second nozzles. When the switch is in a lower position, the cam is centered at the second nozzle such that the second nozzle is in the open state. When the switch is in an upper position, the cam is centered at the first nozzle such that the first nozzle is in the open state.

In some embodiments, and by non-limiting example, the present disclosure relates to a spray mop that includes a handle, a support assembly, a bottle assembly, a bottle seat assembly, and a mop head. The support assembly is connected to the handle. The bottle assembly includes a plurality of support pockets. The plurality of support pockets each define a cavity. The cavity defines a primary lobe with a tapered surface that increases with increasing depth of the cavity. The bottle seat assembly is mounted to the support assembly. The bottle seat assembly defines a bottle interface region that includes a seat surface configured to receive the bottle assembly. The bottle interface region defines a plurality of bottle positioning protrusions that extend upwardly from the seat surface. Each bottle positioning protrusion defines a wall structure that includes a primary wall. The primary wall extends along a path that is tangent to a circumference defined around the support assembly. The mop head is connected to the bottle seat assembly. The plurality of bottle positioning protrusions are configured to engage the corresponding plurality of support pockets on the bottle assembly such that interaction between the plurality of positioning protrusions and the corresponding plurality of support pockets prevents movement of the bottle assembly in a plane generally normal to a bottle axis. The interaction between the plurality of positioning protrusions and the corresponding plurality of support pockets positions the bottle assembly into a desired position adjacent the support assembly when the bottle assembly seats into the bottle seat assembly.

### BRIEF DESCRIPTION OF THE FIGURES

FIG. 1 is a first perspective view of an example mop in accordance with the principles of the present disclosure.

FIG. 2 is a second perspective view of the mop of FIG. 1.

FIGS. 3A and 3B are focused perspective views of an example handle in accordance with the principles of the present disclosure.

FIGS. 4A-4C are focused perspective views of example connector components in accordance with the principles of the present disclosure.

FIGS. 5A-5B are perspective views of an example bottle with an example storage cap in accordance with the principles of the present disclosure.

FIG. 6 is a perspective view on an example bottle without a storage cap in accordance with the principles of the present disclosure.

FIG. 7 is a bottom view of an example quarter-turn bottle cap connected to an example bottle in accordance with the principles of the present disclosure.

FIGS. 8A and 8B are perspective views of an example quarter-turn bottle cap connected to an example bottle with a cut-out section exposing various internal components in accordance with the principles of the present disclosure.

FIG. 9 is a rear focused view of an example mop with an example bottle release mechanism in accordance with the principles of the present disclosure.

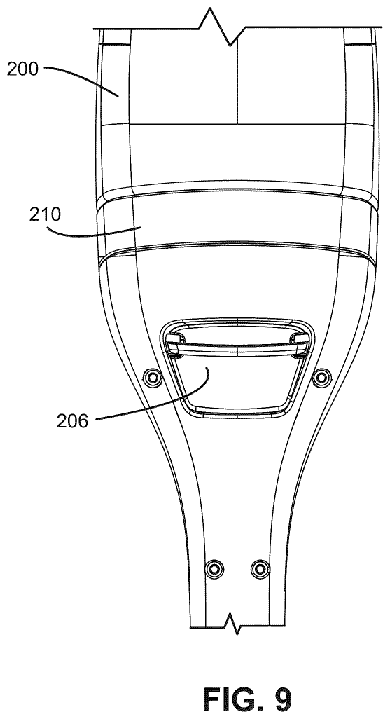

FIG. 10 is a top view of an example bottle seat assembly in accordance with the principles of the present disclosure.

FIG. 11 is a focused side view of an example mop with a cut-out section exposing an example liquid delivery system in accordance with the principles of the present disclosure.

FIG. 12 is a focused side view cross-section of an example mop with an example liquid delivery system in accordance with the principles of the present disclosure.

FIG. 13 is a focused perspective view of an example mop with a cut-out section exposing an example liquid delivery system in accordance with the principles of the present disclosure.

FIG. 14 is a focused perspective view of an example mop head attached to an example mop in accordance with the principles of the present disclosure.

FIG. 15 is a bottom view of an example mop head without an example mop pad in accordance with the principles of the present disclosure.

FIGS. 16A-16C are perspective views of example mop heads with alternative mop head cutouts in accordance with the principles of the present disclosure.

FIGS. 17A and 17B are focused perspective views of an example joint connecting an example mop head to an example support assembly in accordance with the principles of the present disclosure.

FIG. 18 is a perspective view of the joint of FIGS. 17A and 17B connected to an example mop assembly in accordance with the principles of the present disclosure.

FIG. 19 is a perspective view of another example mop head including an example flexible scrubber in accordance with the principles of the present disclosure.

FIG. 20 is a bottom perspective view of an example mop head with a cutout section that includes an example flexible scrubber in accordance with the principles of the present disclosure.

FIGS. 21A and 21B are cross-sectional side views of an example mop head with an example flexible scrubber in a lowered and raised position in accordance with the principles of the present disclosure.

FIG. 22 is a perspective view of an example mop pad with tabs in accordance with the principles of the present disclosure.

FIG. 23 is a perspective view of an example mop pad with an abrasive zig zag pattern on a bottom surface in accordance with the principles of the present disclosure.

FIGS. 24A and 24B are perspective views of an example mop pad with an example integrated flexible scrubber portion in accordance with the principles of the present disclosure.

FIG. 25 is a front view of an example mop that is partially disassembled bottle seat assembly in accordance with the principles of the present disclosure.

FIG. 26 is a focused perspective view of an example mop with a cutout section showing an example bottle seat assembly with an example release member in accordance with the principles of the present disclosure.

FIG. 27 is a perspective view of another example mop in accordance with the principles of the present disclosure.

FIG. 28 is perspective view of another example bottle assembly in accordance with the principles of the present disclosure.

FIG. 29 is another perspective view of the example bottle assembly of FIG. 28.

FIG. 30 is a focused perspective view of the example bottle assembly of FIG. 28.

FIG. 31 is a top view of an example bottle seat assembly in accordance with the principles of the present disclosure.

FIG. 32 is a bottom view of the example bottle assembly of FIG. 28.

FIG. 33 is a side view of a portion of an example bottle seat assembly in accordance with the principles of the present disclosure.

FIG. 34 is a first cross-sectional view of a portion of an example mop in accordance with the principles of the present disclosure.

FIG. 35 is a second cross-sectional view of the example mop of FIG. 34 centered along a cross-section of an example first fluid pathway.

FIG. 36 is an illustration of the cross-sectional view of FIG. 34 with liquid in an example bottle and an example reservoir, showing an example air flow pathway in accordance with the principles of the present disclosure.

FIG. 37 is a view of an example component of an example bottle seat assembly in accordance with the principles of the present disclosure.

FIG. 38 is a focused perspective view of a lower portion of an example mop in accordance with the principles of the present disclosure.

FIG. 39 is a second focused perspective view of the example mop of FIG. 38.

FIG. 40 is a focused perspective view of a lower portion of an example mop in a storage position in accordance with the principles of the present disclosure.

FIG. 41 is a perspective view of an example lower portion of an example joint in accordance with the principles of the present disclosure.

FIG. 42 is a focused perspective view of an example mop head in accordance with the principles of the present disclosure.

### DETAILED DESCRIPTION

Various examples will be described in detail with reference to the drawings, wherein like reference numerals represent like parts and assemblies throughout the several views. Reference to various examples does not limit the scope of the claims attached hereto. Additionally, any examples set forth in this specification are not intended to be limiting and merely set forth some of the many possible embodiments for the appended claims.

Throughout this description, references to orientation (e.g., front(ward), rear(ward), top, bottom, back, right, left, upper, lower, etc.) of the components of the spray device relate to their position when standing upright on an underlying surface and are used for ease of description and illustration only. No restriction is intended by use of the terms regardless of how the components of the spray device are situated on their own. As used herein, the terms “axial” and “longitudinal” refer to directions and orientations, which extend substantially parallel to a centerline of the component or system. Moreover, the terms “radial” and “radially” refer to directions and orientations, which extend substantially perpendicular to the centerline of the component or system. In addition, as used herein, the term “circumferential” and “circumferentially” refer to directions and orientations, which extend arcuately about the centerline of the component or system.

Unless otherwise specified, the following terms as used herein have the meanings provided below. The term “about” generally refers to a range of numbers that one of skill in the art would consider equivalent to the recited value (i.e., having the same function or result). In many instances, the terms “about” may include numbers that are rounded to the nearest significant figure.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

The present disclosure generally relates to a flat mop for use on floors. In certain examples, the mop of the present disclosure is designed for both wet and dry applications, providing efficient cleaning across various surfaces. In certain examples, the mop includes various components, including a handle, a mop support assembly (the mop shaft or pole), an optional bottle, a bottle seat assembly, a joint, a mop head, and a mop pad. In certain examples, when the mop is used for wet applications, the mop receives a bottle with a treatment composition.

In certain examples, the handle is designed for function, ease, and comfort of use. The handle may include a hanging aperture. The handle may include a trigger for actuating the pump in the bottle seat assembly to dispense treatment composition from the bottle through the nozzle and onto the floor.

In certain examples, the mop support assembly supports the handle, the bottle, and the bottle seat assembly. In certain examples, the mop support assembly connects to the mop head through the joint. In certain examples, the mop support assembly also contains the connection mechanisms for actuating the pump in the bottle seat assembly by squeezing the trigger on the handle. In certain examples, the mop support assembly is designed in sections that allow for the mop to be sold in smaller components and assembled for use by the consumer. In certain examples, the mop support assembly includes connectors that facilitate easy assembly.

The mop may optionally include a bottle with a treatment composition. In certain examples, the bottle is used for wet applications. In certain examples, the bottle is designed to be replaced or refilled when it is empty. In certain embodiments, the bottle design includes a storage cap that allows the bottle to be sold on a store shelf. In certain examples, the storage cap is removed when the bottle is placed into the bottle seat assembly. In certain examples, the bottle includes a quarter-turn bottle cap. In certain examples, the quarter-turn bottle cap prevents treatment composition from leaking out of the bottle when the bottle is not placed in the bottle seat assembly. In certain examples, the quarter-turn bottle cap facilitates connecting the bottle to the bottle seat assembly. In certain examples, the quarter-turn bottle cap facilitates refilling of an empty bottle. In certain examples, the quarter-turn bottle cap includes a valve for dispensing treatment composition to the bottle seat assembly.

In certain examples, the bottle seat assembly receives the bottle and the quarter-turn bottle cap. In certain examples, the bottle seat assembly includes a pump that is connected to the trigger through the support assembly. In certain examples, the pump includes a small storage chamber, a piston, and a spring. In certain examples, once the bottle is locked into the bottle seat assembly, the valve on the bottle opens allowing fluid communication between the interior of the bottle and the pump. In certain examples, squeezing the trigger compresses the spring, creating positive pressure in the storage chamber, which pushes liquid from the storage chamber out of a nozzle. In certain examples, releasing the trigger causes the spring to expand, creating a negative pressure in the storage chamber, which pulls liquid from the interior of the bottle.

In certain examples, the bottle seat assembly actuates the valve inside the quarter-turn bottle cap to open the bottle and allow liquid to flow from the bottle to the storage chamber. In certain examples, when the quarter-turn bottle cap is engaged with the bottle seat assembly, the bottle seat assembly engages an internal valve mechanism opening a passageway between the bottle and the storage chamber. In certain examples, upon actuation of the trigger, the pump mechanism is compressed. In certain examples, trigger actuation decreases the volume of the storage chamber, forcing liquid through a one-way valve and into a conduit leading toward the nozzle.

In certain examples, the bottle seat assembly includes one or more nozzles. In certain examples with more than one nozzle, the nozzles may be selected to provide different spray patterns, different spray angles, different volumes of treatment composition, different spray pressures, etc., or any combination of these features. The bottle seat assembly may include a switch for selecting which nozzle is used to dispense the treatment composition onto the floor.

In certain examples, the bottle seat assembly connects to the mop head by a joint. In certain examples, the joint allows for movement of the mop head in at least two different directions. In certain examples, the joint allows the mop head to pivot or swivel relative to the support assembly. In certain examples, the joint provides for maneuverability around obstacles, including furniture, edges, corners, or other home features. In certain examples, the joint allows for consistent pressure to be applied to the floor or surface, without any portion of the mop head lifting.

In certain examples, the mop head is generally planar. In certain examples, the mop head includes cutouts on the short sides that coordinate with tabs on the mop pad. In certain examples, the tabs allow the user to remove the dirty mop pad without having to touch the bottom of the mop pad. In certain examples, the mop head includes a flexible scrubbing portion that allows a portion of the bottom of the mop head to be selectively engaged when additional scrubbing is needed. In certain examples, during normal cleaning, the flexible scrubbing portion of the mop head rests above the contact plane of the mop head. In certain examples, a user applies pressure to the support assembly to push the flexible scrubbing portion down to be planar with, or slightly below, the rest of the mop head. The flexible scrubbing portion may coordinate with a mop pad that has a coordinating section with a different material, e.g., a different fiber or an abrasive section.

In certain examples, a mop pad attaches to the bottom of the mop head. The mop pad may be single-use or multi-use. In certain examples, the mop pad is washable. The mop pad can be attached to the mop head using hook and loop or other attachment methods. The mop pad is designed to capture dirt, dust, and/or liquid while withstanding multiple uses between being washed. In certain examples, the mop pad includes tabs on the short end of the mop pad that coordinate with the cutout sides (positioned within the cutout sides) of the mop head to allow for removal of the mop pad from the mop head without touching the underside of the mop pad. In certain examples, the mop pad includes an abrasive section on the bottom of the mop pad. The abrasive section could be in a pattern such as a zig zag pattern. The abrasive section could also be centrally located on the mop pad to coordinate with a mop head design that includes a flexible scrubber portion. In certain examples, the mop pad is designed to be used in a dry setting to remove dust and other debris such as hair or fur.

In certain examples, the handle, support assembly, and mop head may be made of a lightweight but durable material such as aluminum or plastic. In certain examples, the mop head may be made of a resilient and flexible material, such as polypropylene or rubber.

In certain examples, the mop is designed to be used on various floor surfaces including, for example, wood, tile, linoleum, marble, vinyl, luxury vinyl tile, stone, ceramic, terrazzo, etc.

Reference is now made to the Figures.

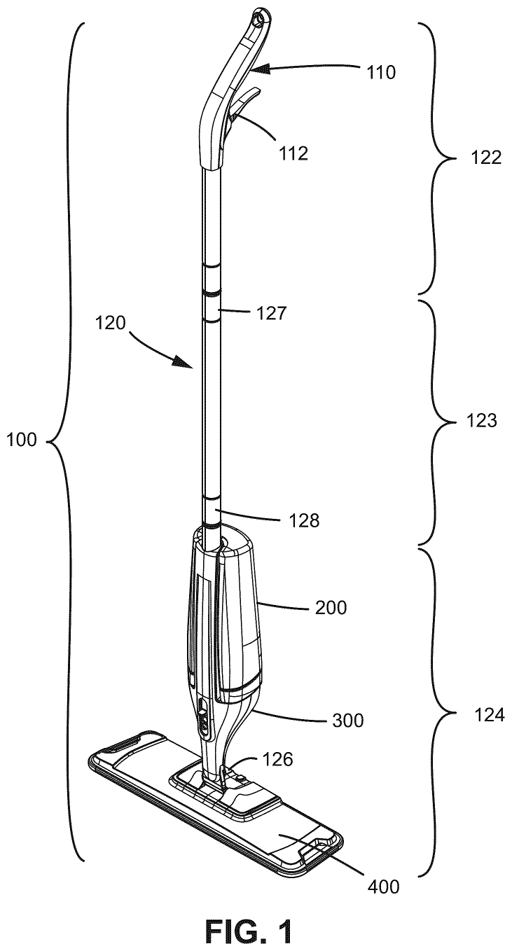

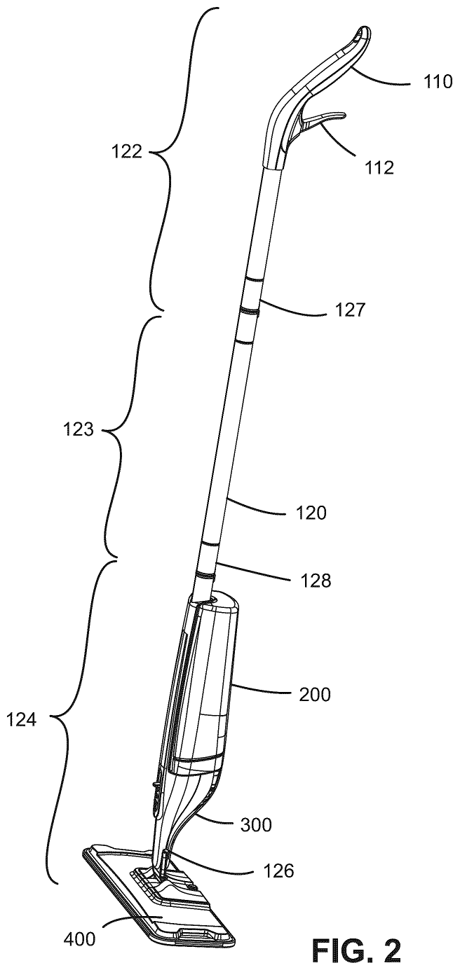

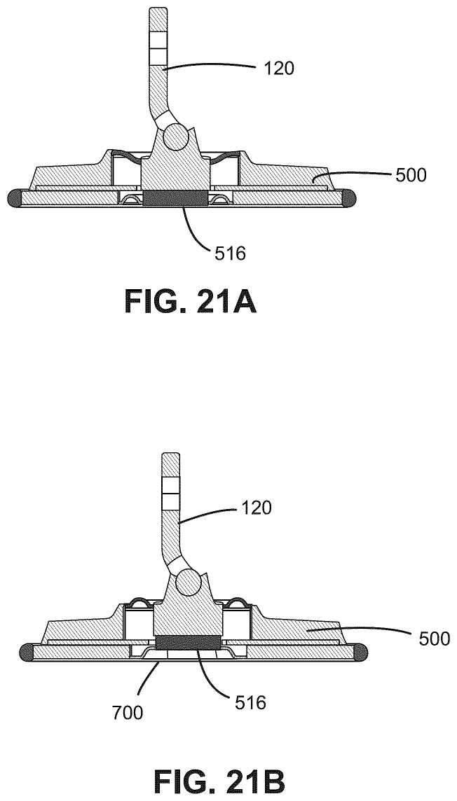

FIGS. 1 and 2 show a mop according to the present disclosure. In certain examples, a mop 100 includes a handle 110, a support assembly 120, a bottle seat assembly 300, a bottle assembly 200, a mop head 400, and a mop pad 600. In certain examples, the mop 100 includes an elongated vertical support assembly 120. In certain examples, the support assembly 120 includes multiple sections that are connected together. FIGS. 1 and 2 show the support assembly 120 with three sections 122, 123, and 124 connected at joints 127 and 128. In certain examples, section 122 defines an upper portion. In certain examples, section 122 connects to the handle 110. In certain examples, section 123 defines a middle portion of support assembly 120. In certain examples, section 124 defines a lower portion. In certain examples, section 124 is connected to the bottle seat assembly 300. In certain examples, the bottle seat assembly 300 is configured to receive and secure a bottle assembly 200. In certain examples, the bottle assembly 200 contains a treatment composition. In certain examples, a bottom of the bottle seat assembly 300 includes a joint 126 that connects the bottle seat assembly 300 to the mop head 400. In certain examples, the mop head 400 may include a mop pad 600 (shown in FIGS. 21-23).

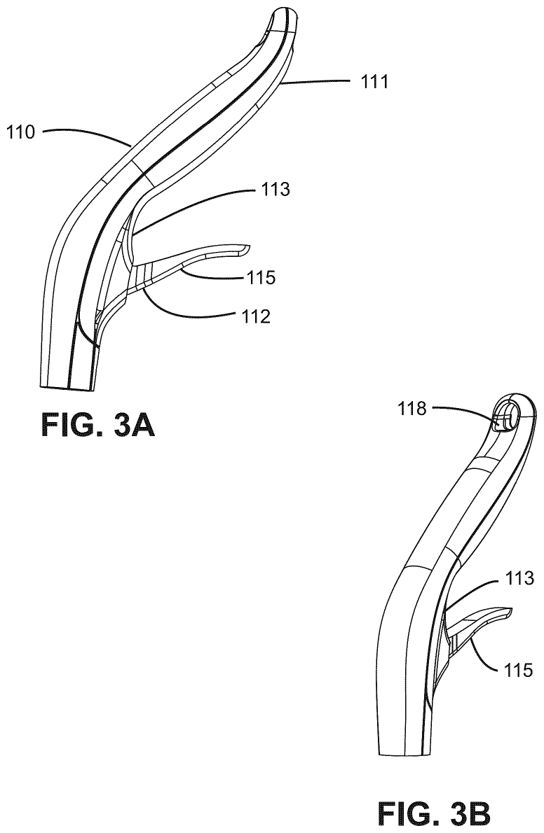

FIGS. 3A and 3B show detailed views of the handle 110. In certain examples, the handle 110 includes a trigger 112 and a hanging aperture 118. The handle 110 is designed for user comfort during repeated use of the trigger while mopping. In certain examples, the handle 110 curves upward at an angle 111 near the hanging aperture 118 to provide a backstop for the heel of a user's hand to rest against when mopping. In certain examples, a bottom region of the handle includes a recess 113 for resting the fingers while gripping the handle. In certain examples, the trigger 112 is designed to include a recess 115 when engaging the trigger 112. During operation, the trigger 112 on the handle 110 actuates a pump mechanism 215 to dispense a treatment composition. In certain examples, the hanging aperture 118 provides a storage mechanism when the mop 100 is not being used.

In certain examples, both the recess 113 and the recess 115 contribute to the ease of use, and comfort for a user when operating the mop 100. In certain examples, the recess 113 provides a space for the user's fingers to rest when not engaged with the trigger 112. In certain examples when gripping the handle 110, a user may place all fingers, except their thumb, in the recess 113 to provide a secure grip of the mop 100. When the user engages the trigger 112, the recess 115 on the trigger 112 provides a space for the user to rest their finger(s) on the trigger.

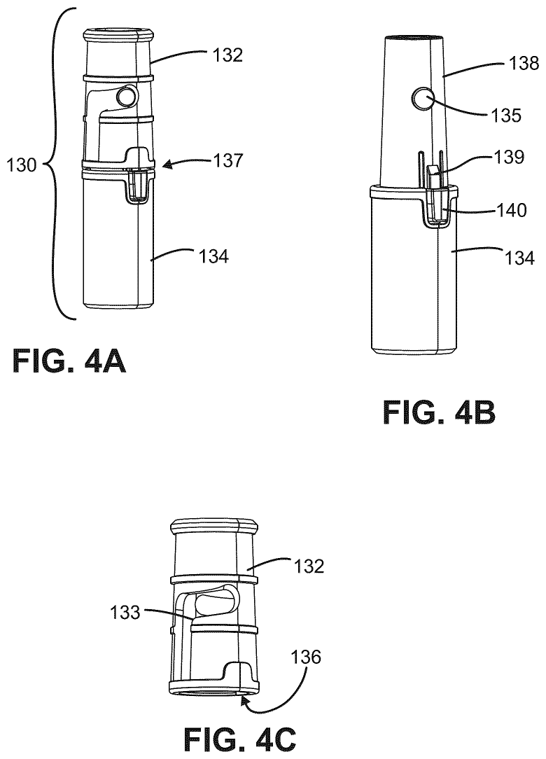

In certain examples, the handle 110 connects to the first section 122 of the support assembly 120. In certain examples, each joint 127, 128 includes a connector 130, described in detail below. In certain examples, the first section 122, second section 123, and third section 124 are connected to assemble the support assembly 120. FIGS. 4A-4C show a connector 130 for the support assembly 120. In certain examples, the connector 130 includes: a female coupling component 132 and a male coupling component 134. In certain examples, the coupling components 132, 134 interact with each other to provide secure connection at the joints 127 and 128. In certain examples, the connector 130 enables the support assembly 120 to be separated into manageable sections while maintaining structural integrity during use. In certain examples, the female coupling component 132 includes a threaded or concave portion 133 that runs along a length of the female coupling component 132. In certain examples, the threaded portion 133 mates with the male coupling component 134. In certain examples, the male coupling component 134 has a prong or protrusion 135 that allows the male coupling component 134 and the female coupling component to be removably coupled. In certain examples, a tapered contact surface 138 of the male coupling component 134 is inserted into the female coupling component 132, and the connector 130 is twisted, locking the prong or protrusion 135 into the threaded or concave portion 133. In certain examples, the female coupling component 132 and male coupling component 134 are each connected to a portion of the support assembly 120. In certain examples, the female coupling component 132 and the male coupling component 134 are engineered to ensure proper alignment during assembly, secure attachment between support assembly sections, easy assembly and disassembly when needed, and structural stability during cleaning operations. In certain examples, the first section 122 of support assembly 120 ends at the handle 110. In certain examples, the second section 123 of the support assembly 120 ends at the bottle seat assembly 300. In certain examples, the third section 124 of the support assembly 120 ends at the joint 126.

In certain examples, the connector 130 also includes a locking feature 137. In certain examples, the locking feature includes a locking tab 139, a release button 140, and a locking recess 136. In certain examples, the male coupling component 134 includes a plastic spring finger that contains the locking tab 139 and the release button 140. In certain examples, the female coupling component 132 includes the locking recess 136. In certain examples, the locking tab 139 engages the locking recess 136 when the female coupling component 132 and male coupling component 134 are assembled. In certain examples, the tapered contact surface 138 will naturally depress the locking tab 139 as the female coupling component 132 and male coupling component 134 are brought together. In certain examples, once the female coupling component 132 and male coupling component 134 reach the assembled state, the locking recess 136 provides a space for the locking tab 139 to come to rest, allowing the locking tab 139 to spring forward. The engagement of the locking tab 139 into the locking recess 136 prevents the female coupling component 132 and male coupling component 134 from twisting relative to each other. The release button 140 allows the user to selectively disengage the locking tab 139 from the locking recess 136 so that the female coupling component 132 and male coupling component 134 can be disassembled.

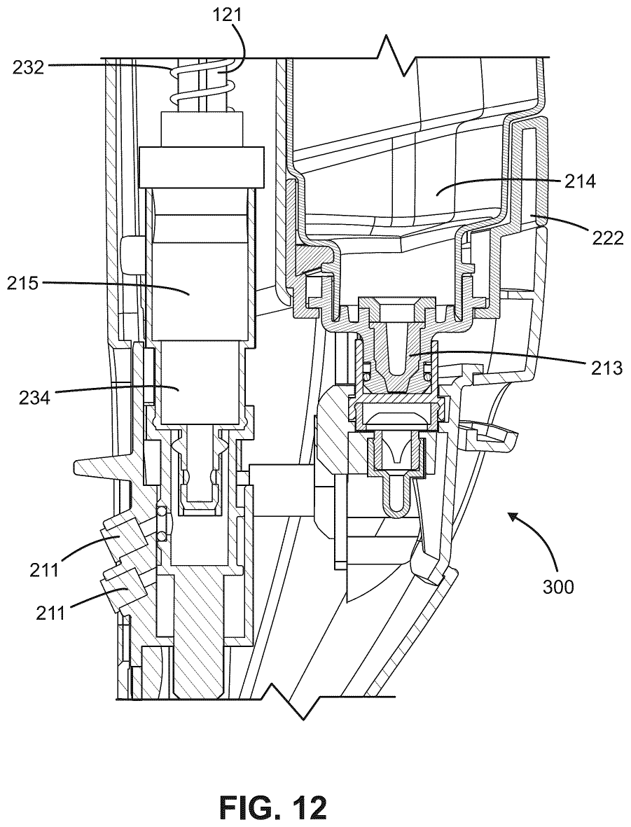

In certain examples, the interior of support assembly 120 contains a rod 121 (partially shown in FIG. 12) that runs from the interior of the handle down to a spring 232 for the pump. In certain examples, actuation of the trigger 112 causes the trigger 112 to push the rod 121 down against the spring 232 and force the treatment composition out of a nozzle 211. When the trigger 112 is released, the spring 232 pushes the rod 121 back to its neutral position.

In certain examples, the support assembly 120 connects to the bottle seat assembly 300, which extends vertically to the mop head connection at joint 126. In certain examples, the bottle seat assembly 300 is configured to receive the bottle assembly 200 with the treatment composition. In certain examples, the position of the bottle assembly 200 and the bottle seat assembly 300 balances the weight of the treatment composition bottle assembly 200 underneath the support assembly 120 to provide stability during use.

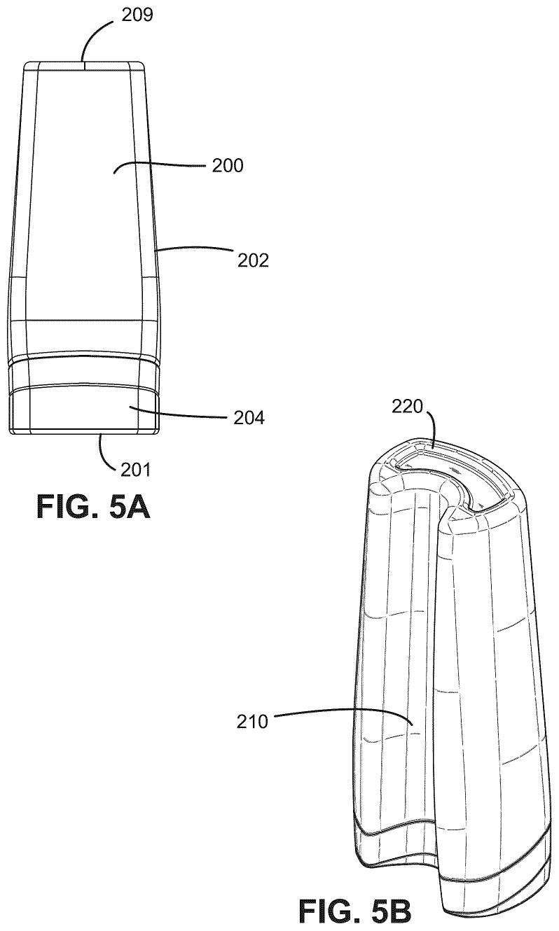

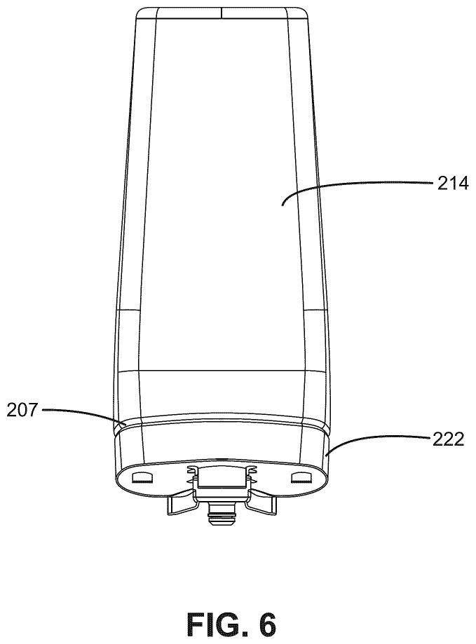

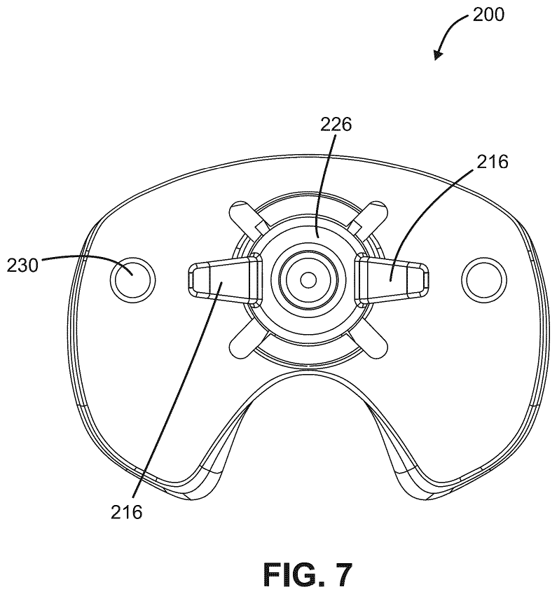

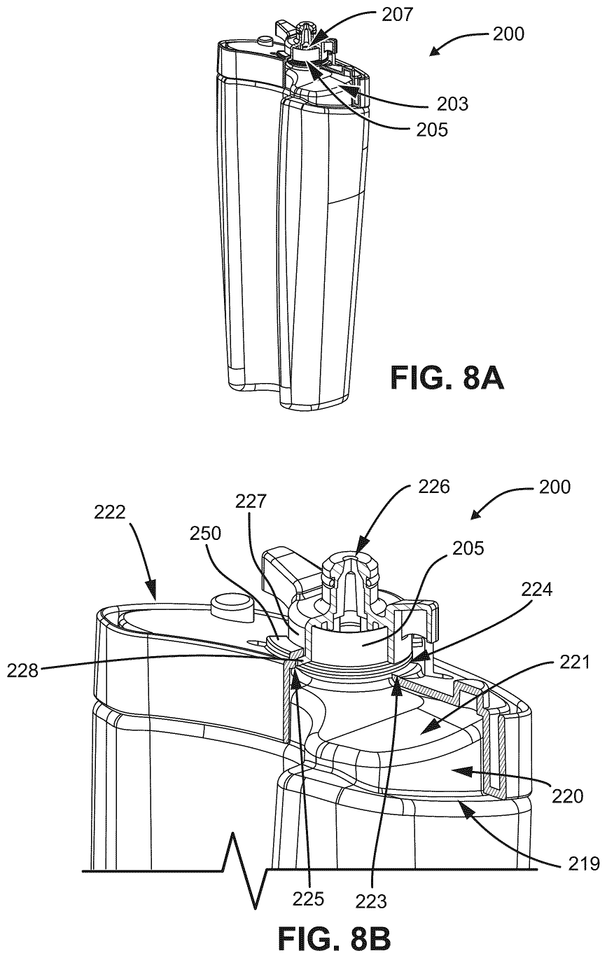

FIGS. 5-8B illustrate various aspects of the bottle assembly 200. In certain examples, the bottle assembly 200 includes a bottle 214, an attachment 222, and a quarter-turn bottle cap 226. The bottle assembly 200 is a container assembly for holding a treatment composition. In certain examples, the bottle 214 includes a bottom 201, a body 202, a shoulder 203, a neck 205, an opening 207, and top 209. In certain examples, the body 202 is shaped to have a gap 210 that coordinates with the support assembly 120 when the bottle assembly 200 is placed in the bottle seat assembly 300. In certain examples, the shoulder 203 includes a ledge 219, wall 220, and end 221 for receiving an attachment 222 (visible in FIGS. 8A-B).

In certain examples, the attachment 222 fits over the end 221 of the shoulder 203. In certain examples, the neck 205 extends outward from the shoulder 203 at the bottom 201. In certain examples, the attachment 222 includes a first surface 223 that fits underneath a ring 224 of the neck 205 to secure the attachment 222 to the bottom 201 of the bottle 214. In certain examples, the attachment 222 also includes a second surface 225, and a ledge 250 to retain the quarter-turn bottle cap 226. In certain examples, the quarter-turn bottle cap 226 includes an exterior wall 227 that forms a cylindrical pocket that fits over the neck 205 and allows the quarter-turn bottle cap 226 to sit on a top of the ring 224. In certain examples, the quarter-turn bottle cap 226 includes a ledge 228 that also sits on top of the ring 224 but underneath the second surface 225, locking the quarter-turn bottle cap 226 to the attachment 222. In certain examples, the quarter-turn bottle cap 226 includes one or more wings 216 extending radially outward from the exterior wall 227. In certain examples, the one or more wings 216 allow the quarter turn bottle cap 226 to rotate between a locked and unlocked position relative to the attachment 222. In certain examples, the wings 216 also allow the quarter-turn bottle cap 226 to be completely removed from the neck 205 if a user wants to refill an empty bottle 214.

In certain examples, the bottle assembly 200 includes a storage cap 204 (shown in FIG. 5). In certain examples, the storage cap 204 covers the quarter-turn bottle cap 226 when the bottle assembly 200 is on a store shelf or not in use. In certain examples, the storage cap 204 may be discarded when the bottle assembly 200 is placed in bottle seat assembly 300. Some users may choose to keep storage cap 204 for storage purposes when the bottle assembly 200 is not in the mop 100.

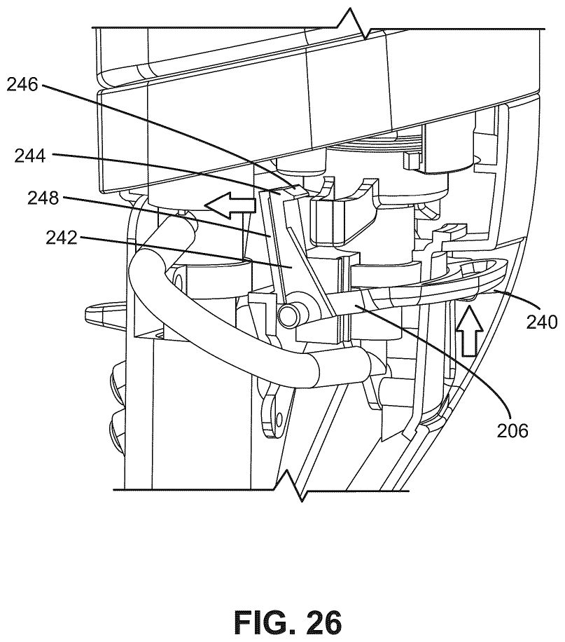

Referring to FIG. 26, in certain examples during operation, a user takes bottle assembly 200, removes storage cap 204, orients the bottle assembly 200 so that the quarter-turn bottle cap 226 is facing down, inserts the quarter-turn bottle cap 226 into the bottle seat assembly 300 (described in more detail below) and presses straight down along the axis of the bottle neck 205 to lock the bottle assembly 200 into the bottle seat assembly 300. In certain examples, the bottle seat assembly 300 includes a release member 206 to lock bottle assembly 200 into place. In certain examples, the release member 206 is rotationally connected within the bottle seat assembly 300. In certain examples, the release member 206 includes a lever 240 and first and second arms 242 that extend at an angle from lever 240. In certain examples, the arms 242 each include a catchpoint 244. In certain examples, the catchpoint 244 includes a ramp 246. In certain examples, when the bottle assembly 200 is inserted into the bottle seat assembly 300, the wings 216 on the quarter-turn bottle cap 226 engage ramp 246 on the catchpoint 244 causing the release member 206 to deflect out of the way and allow the wings 216 to slide past. Once the bottle assembly 200 is fully seated, the wings 216 will drop below the catchpoint 244 and the release member 206 will spring back into place locking the bottle assembly 200 down. In certain examples, a flexible member 248 is positioned behind the catchpoint 244. In certain examples, the flexible member 248 provides the spring force that pushes the release member 206 back into the locked position. To remove the bottle assembly 200, the lever 240 is lifted, which rotates the first and second arms 242 away from the wings 216. Springs inside the bottle seat assembly 300 will then push the attachment 222 away from the bottle seat assembly 300, clearing the wings of the catchpoint 244 and allowing the bottle assembly 200 to be removed. In certain examples, when the lever 240 is in a locked position, the quarter-turn bottle cap 226 is prevented from rotating, and thereby prevented from detaching from the bottle 214.

In certain examples, a treatment composition is located inside of the bottle 214. The treatment composition may be a cleaning composition for a floor, a disinfectant composition, a floor polishing composition, a dusting composition, and other floor treatment compositions. The floor treatment composition may include surfactants, antimicrobial agents, glossing agents, and the like. When all of the treatment composition inside of the bottle assembly 200 is used, the bottle assembly 200 is removed from the bottle seat assembly 300 by pulling up on the release member 206, removing the bottle assembly 200, discarding or recycling the bottle assembly 200 and replacing it with a new bottle assembly 200, or refilling the empty bottle assembly 200 with more treatment composition and inserting it back into bottle seat assembly 300.

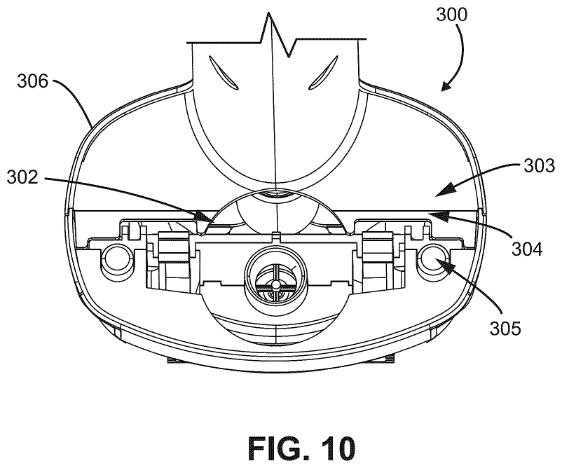

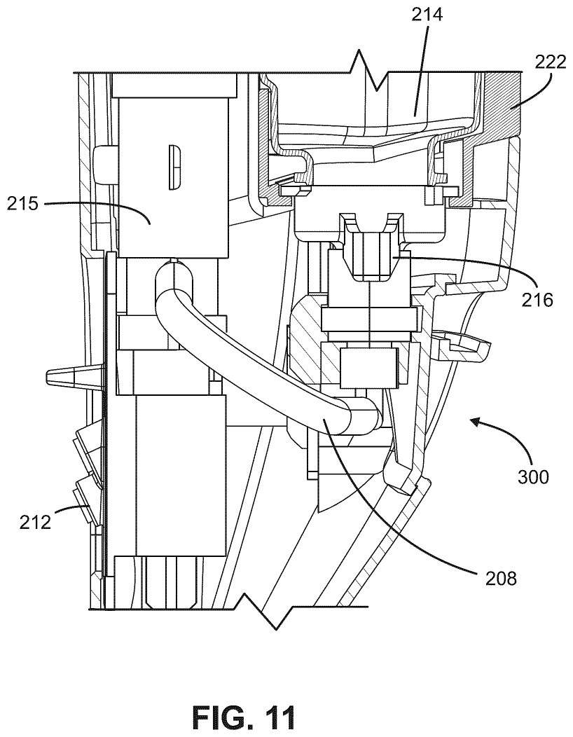

FIGS. 10-13 show the bottle seat assembly 300. Bottle seat assembly 300 is mounted to the support assembly 120 and is configured to receive and secure the bottle assembly 200. In certain examples, the bottle seat assembly 300 includes a retaining member 303. In certain examples, the retaining member 303 is shaped to coordinate with the shape of the bottle assembly 200. In certain examples, the retaining member 303 includes a bottom surface 304 and a wall 306 that extends up a perimeter of the retaining member 303 such that the bottle assembly 200 does not tip or fall out of the retaining member 303. In certain examples, the retaining member 303 forms a seat for the bottle assembly 200 to sit in. In certain examples, the retaining member 303 also includes one or more ejection pins 305 that engage posts 230 when the bottle assembly 200 is in the locked position within the bottle seat assembly 300. In the locked position, the ejection pins 305 are pushed down, compressing springs (not shown) underneath. When the bottle assembly 200 is unlocked, the springs will expand causing the ejection pins 305 to raise and push the bottle assembly 200 out of the bottle seat assembly 300. In certain examples, the retaining member 303 also includes a recess 302 for receiving the quarter-turn bottle cap 226. In certain examples, the recess 302 is shaped to coordinate with the shape of the quarter-turn bottle cap 226. In certain examples, when the quarter-turn bottle cap 226 is inserted into the recess 302, a valve on the bottle assembly 200 is opened and the treatment composition can leave the interior of the bottle 214 when the trigger 112 is actuated (shown in FIG. 12).

In certain examples, the bottle assembly 200 is locked into the recess 302 of the retaining member 303 by the arms 242 of the release member 240 contacting the one or more wings 216. The shape of the retaining member 303 ensures for a secure connection between the bottle assembly 200 and the bottle seat assembly 300. In certain examples, the bottle assembly 200 is easily removed from the bottle seat assembly 300 by pulling upwards on the lever to disconnect the arms 242 from the wings 216. In certain examples, the ejection pins 305 will push the bottle assembly 200 out of the bottle seat assembly 300.

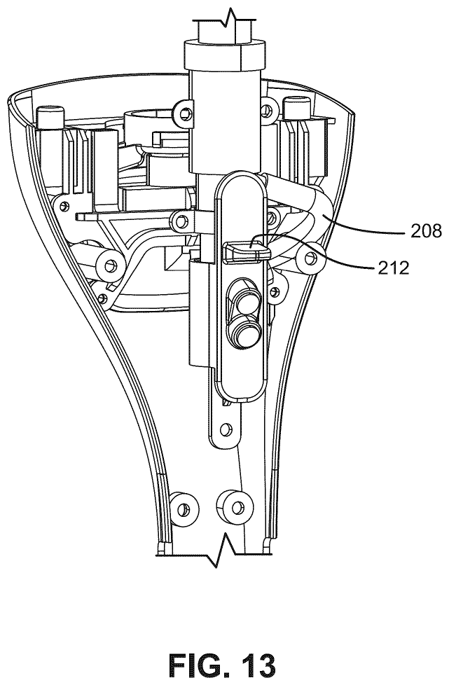

In certain examples, the bottle seat assembly includes pump mechanism 215. In certain examples, the piston 215 is held in an upper position by a spring 232. In certain examples, the piston 215 includes a chamber 234 that is fluidly connected to the bottle assembly 200 and to one or more nozzles 211. In certain examples, the piston 215 works as a two-stroke pump. When the trigger 112 is actuated, the trigger 112 pushes the piston and compresses the spring 232. This creates positive pressure in the chamber 234 and causes treatment composition to flow out of the nozzles 211 and onto the floor. When the trigger 112 is released, the spring 232 pushes the piston pump back into its resting, upper, or expanded position, which creates a negative pressure in the chamber 234 and causes treatment composition to flow out of bottle assembly 200 and into chamber 234. In certain examples, the bottle seat assembly 300 optionally includes a switch 212, shown in FIG. 13, that allows the user to select one or both of the nozzles 211. In certain examples, the switch 212 may slide or rotate in order to move between the nozzles 211. In embodiments with more than one nozzle, the nozzles may be selected to provide different spray patterns, different spray angles, different volumes of treatment composition, different spray pressures, or a combination of these features. Exemplary spray patterns include mist, full cone, hollow cone, fan, or jet patterns. In some embodiments, the same pattern may be used for both nozzles, but the spray angle may be different (e.g., one wide fan spray and one narrow fan spray). This allows a user to conserve treatment composition when it is not needed but use more treatment composition, a more focused spray, or higher pressure for more soiled surfaces.

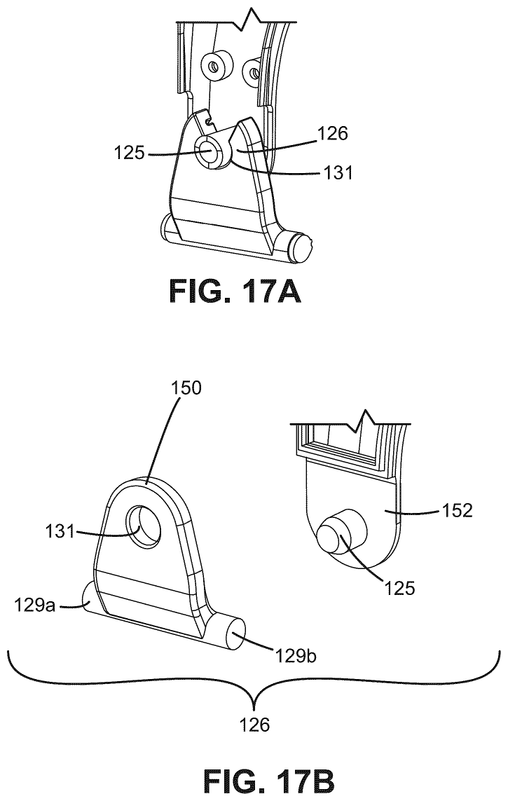

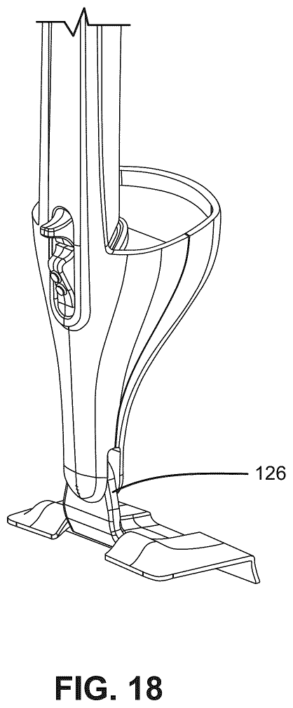

In certain examples, the bottle seat assembly 300 is connected to the mop head 400 via the joint 126. FIG. 18 shows the joint 126 connecting the bottle seat assembly 300 to the mop head 400. FIGS. 17A and 17B show a cutaway view of the joint 126. In certain examples, the joint 126 allows the mop head 400 to move in multiple directions relative to the support assembly 120. In certain examples, the mop head is able to move front-to-back and side-to-side relative to the support assembly 120. In certain examples, the joint 126 is made of an upper part 152 and a lower part 150. In certain examples, the lower part 150 includes two pins 129a and 129b that insert into the mop head 400 and allow the support assembly 120 to move in a front-to-back motion relative to the mop head 400. In certain examples, each of the pins 129a and 129b protrude on the horizontal axis to engage with the mop head 400. In certain examples, the pins 129a and 129b reversibly lock the mop head 400 into place on the joint 126, completing connection of the support assembly 120 to the mop head 400. In certain examples, the lower part 150 includes a hole 131 that coordinates with a post 125 on the upper part 152 of joint 126. In certain examples, the rotation of hole 131 around the post 125 allows the support assembly 120 to move in a side-to-side motion relative to the mop head 400. In certain examples, the movement in two planes allows the mop head 400 to easily move in multiple directions when cleaning and enabling effective contact between the mop head 400 and the floor surface during cleaning operations.

In another embodiment, the rotation hole 131 is not fully enclosed, allowing the lower part 150 to snap over the post 125 making it so that the connection can be disassembled.

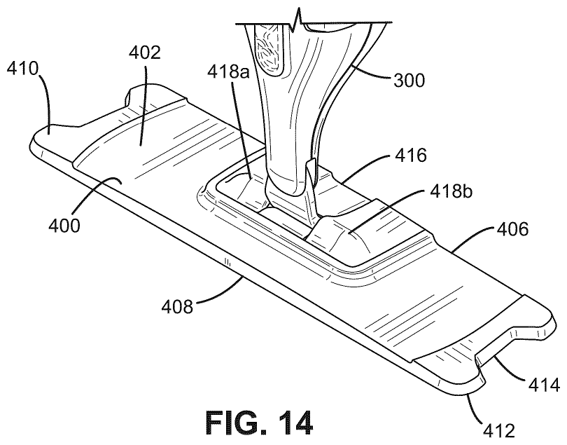

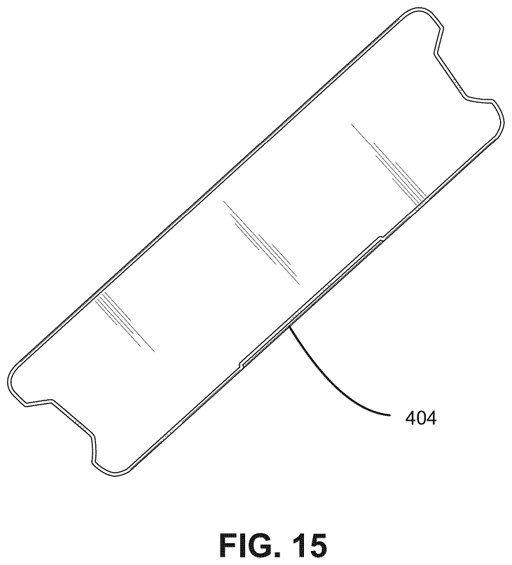

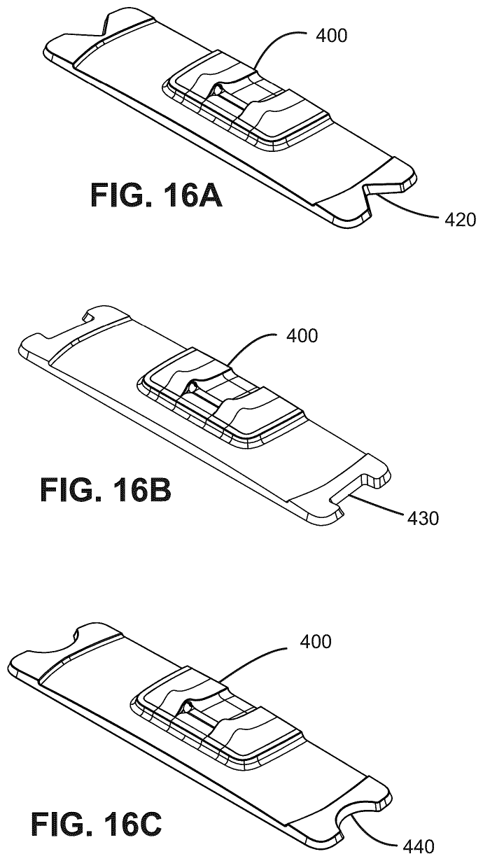

FIG. 14 shows an embodiment of the mop head 400. Mop head 400 is connected to the bottle seat assembly 300 via the joint 126. In certain examples, the pins 129a and 129b of the lower part 150 of the joint 126 insert into two pin cavities 418a, 418b on the mop head 400. In certain examples, the mop head 400 includes a top side 402, a bottom side 404, a first transverse side 406, a second transverse side 408, a first lateral side 410, and a second lateral side 412. In certain examples, the mop head 400 optionally includes a cutout 414 on the first lateral side 410 and/or the second lateral side 412. In certain examples, the cutout 414 is configured to receive tabs 602 from a mop pad 600, 700. The cutouts 414 may have different shapes. As shown in FIG. 14, in certain examples, the cutouts 414 are generally trapezoidal. FIGS. 16A-16C show alternative configuration for the cutouts 414 including a notched cutout 420, a square cutout 430, and a semi-circular cutout 440. FIG. 15 shows the bottom 404 of the mop head 400 with cutouts 414. In certain examples, the bottom 404 of the mop head 400 may include hooks for attaching a mop pad 600 to the bottom of the mop head 400. In certain examples, the cutouts 414 on mop head 400 work in conjunction with tabs 602 on the mop pad 600. In certain examples, the cutouts 414 are shaped to follow a contour of the tabs 602. This design feature enables users to remove soiled mop pads without directly touching the dirty pad surface. In other examples, the mop pads may be attached by hook and loop connections, grippers, or slots on the top or another surface of the mop head.

In certain examples, the mop head 400 also optionally includes a channel 416. In certain example, the channel 416 is configured to receive a width and a thickness of the joint 126 and a bottom portion of the bottle seat assembly 300 when the joint 126 is rotated all the way down such that the joint 126 is resting in channel 416. This provides a storage position for the mop 100 when the mop is not being used.

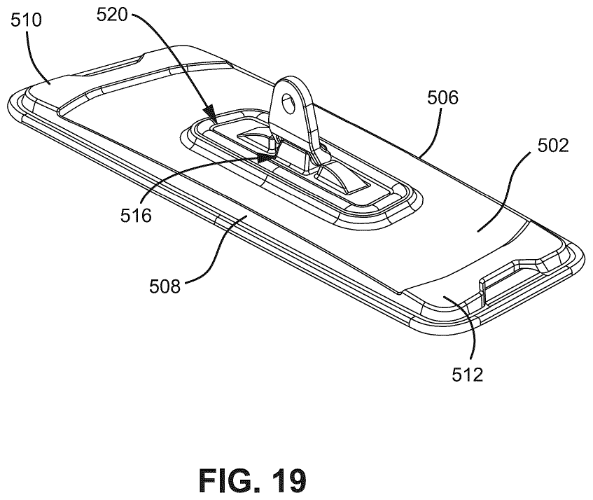

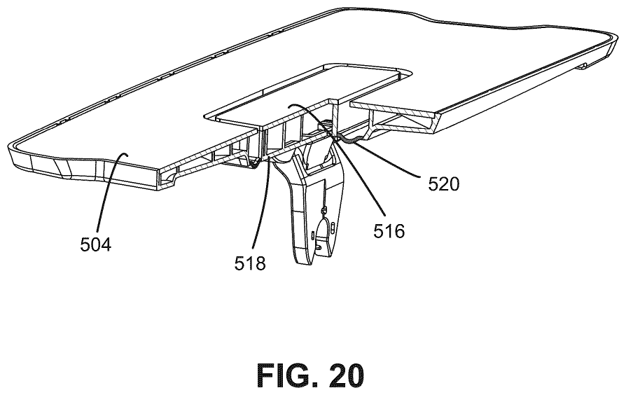

FIGS. 19 and 20 show an alternative embodiment mop head 500 which includes a flexible scrubber portion 516. In certain examples, the mop head 500 includes a top side 502 and multiple edges defined by a first transverse side 506, a second transverse side 508, a first lateral side 510, and a second lateral side 512.

A distinguishing feature of the mop head 500 is the flexible scrubber portion 516 which is incorporated into the mop head 500. In certain examples, the flexible scrubber portion 516 is designed to help remove difficult-to-clean soils from the floor surface. In certain examples, the flexible scrubber portion 516 may be made from a flexible rubber, for example, TPE (thermoplastic elastomer), or a harder plastic material.

In certain examples, the flexible scrubber portion 516 is normally moved between two positions, a first/up position and a second/down position. In certain examples, the “up” position (shown in FIGS. 19 and 21B) is the default position during most cleaning. In the first position/up position, the flexible scrubber portion 516 sits above a cleaning plane of the mop head and does not engage the floor. In the second position/down position, the user pushes on support assembly 120 thereby depressing the flexible scrubber portion 516 and causing the flexible scrubber portion 516 to engage with the floor through the mop pad (shown in FIG. 21A). In certain examples, the flexible scrubber portion 516 facilitates the removal of difficult-to-remove soils in a continuous motion with normal mopping. Additionally, the flexible scrubber portion 516 eliminates the need for a user to scrape or remove difficult-to-remove soils by hand.

In certain examples, the flexible scrubber portion 516 is positioned between the first transverse side 506 and second transverse side 508, and between first lateral side 510 and second lateral side 512 of mop head 500. In certain examples, the flexible scrubber portion 516 has a flexible hinge 520 that works in conjunction with the joint 126. In certain examples, the flexible scrubber portion 516 includes a block 518 (shown in FIG. 20) that is connected to the top 502 of the mop head 500 by the flexible hinge 520. In certain examples, the mop head 500 includes a bottom 504 where the block 518 of the flexible scrubber portion 516 extends through to contact the floor or surface.

FIGS. 21A-B illustrate the flexible scrubber portion 516 in the first and second positions. FIG. 21A shows the flexible scrubber portion 516 lowered and engaged with a surface in the second position, while FIG. 21B shows the flexible scrubber portion 516 raised and not engaged with a surface in the first position. During activation, the user pushes on the support assembly 120 and down through joint 126 to depress the block 518. In certain examples, the flexible hinge 520 connects the block 518 to the top 502 of the mop head 500. In certain examples, the block 518 engages with the mop pad 700 (best shown in FIG. 21B) and exerts force on the center of the mop pad 700. In some embodiments, the flexible scrubber portion 516 is designed to engage with a mop pad that has features in the same shape as the scrubber portion, for example, a second material that is surrounded by a different first material that forms the rest of the mop pad 700. In certain examples, the second material may be an abrasive material designed to help remove soil. In certain examples, the second material could also be the same materials as the first material but provided in a different fiber configuration, fiber thickness, weave, or pattern that provides a scrubbing benefit.

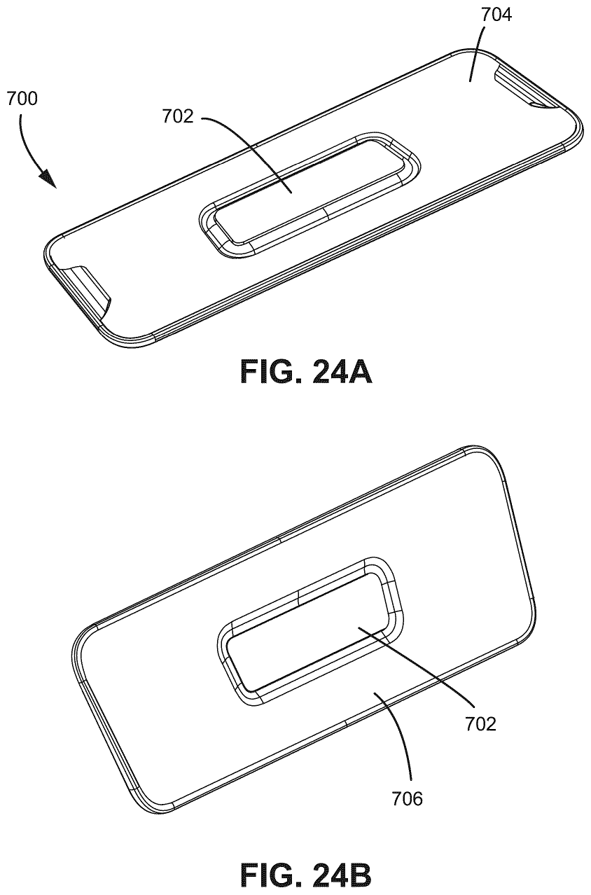

In FIGS. 24A-B, the mop pad 700 includes a flexible scrubber portion 702 that is integrated directly into the pad construction. In certain examples, the flexible scrubber portion 702 is positioned between a first side 704 and second side 706 of the mop pad. In certain examples, the flexible scrubber portion 702 of the mop pad 700 may include extra fabric that allows the abrasive material to attach to the block 518 and rest above the floor surface when the flexible scrubber portion 516 is in the first position. In this way, any abrasive material would not constantly touch the floor. When a user wants to engage the scrubbing feature, the user pushes the flexible scrubber portion 516 to the second position. In certain examples, the block 518 lowers to the floor and applies pressure to the mop pad 700, bringing the flexible scrubber portion 702 of mop pad 700 into contact with the floor.

In another embodiment, the mop pad is always in contact with the floor but selectively experiences more pressure in that central portion creating a localized high pressure area for spot cleaning.

The mop pads of the present disclosure may be made out of various materials depending on the intended use and performance. Suitable materials include microfiber, cotton, polyester, cellulose, and other blended fabrics that facilitate high absorbance, dirt and dust retention, and even moisture distribution for wet cleaning. Microfiber is a preferred material for its ability to be gentle on delicate flooring surfaces while still maintaining absorbency and dirt/dust retention. Mop pads may be formed from a desired material with an absorbent core sewn in the middle.

Mop pads may be single-use and disposable for ease of use, or they may be multi-use washable mop pads. Washable mop pads provide eco-friendly and cost-saving alternatives, while maintaining their effectiveness and withstanding repeated washings. In some embodiments, the surface of the mop pad that is in contact with the floor may feature a looped, or otherwise textured appearance to facilitate better cleaning and performance for specific applications. In other embodiments, the surface of the mop pad that contacts the floor may be smooth or include a scrubbing portion for hard-to-clean messes or soils.

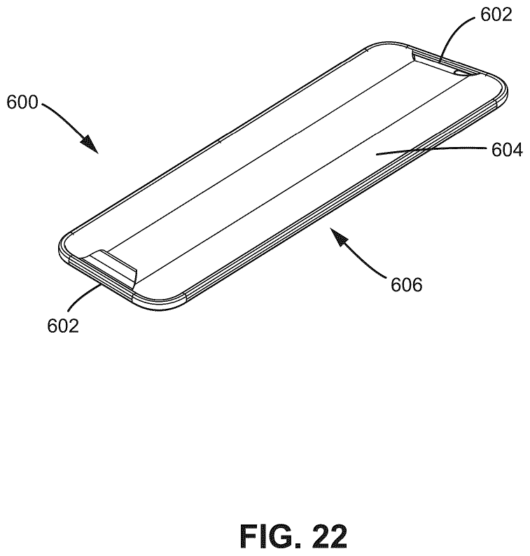

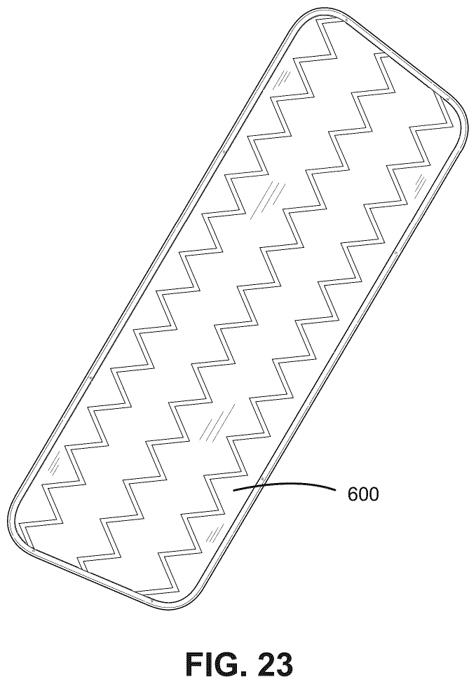

FIGS. 22 and 23 show additional mop pad configurations. FIG. 22 shows a mop pad 600 with a first side 604, a second side 606, and tabs 602 positioned along edges to assist with removal of the mop pad 600 from the mop head without having to touch the dirty part of the mop pad. In certain examples, the tabs 602 coordinate with the cutouts 414 on the mop head 400 for secure attachment. FIG. 22 shows tabs on both sides of the mop pad 600. In certain examples, tabs could also be used on one side only and still provide a benefit of removing the pad without having to touch the dirty mop pad. FIG. 23 shows the bottom of a mop pad 600 with an optional abrasive pattern incorporated into the bottom. An abrasive feature could be incorporated directly into the pad as an alternative to a mop head with a flexible scrubbing portion. FIGS. 24A-24B show another mop pad 700 with a first side 704, a second side 706, and a flexible scrubber portion 702 integrated into the pad construction. In certain examples, the flexible scrubber portion 702 extends through the second side 706 of the mop pad 700, at least when pressure is applied. In certain examples, the force that extends through the support assembly 120 pushes the block 518 into the flexible scrubber portion 702, placing it on the same plane or a slightly lower plane than the remainder of the mop pad 700.

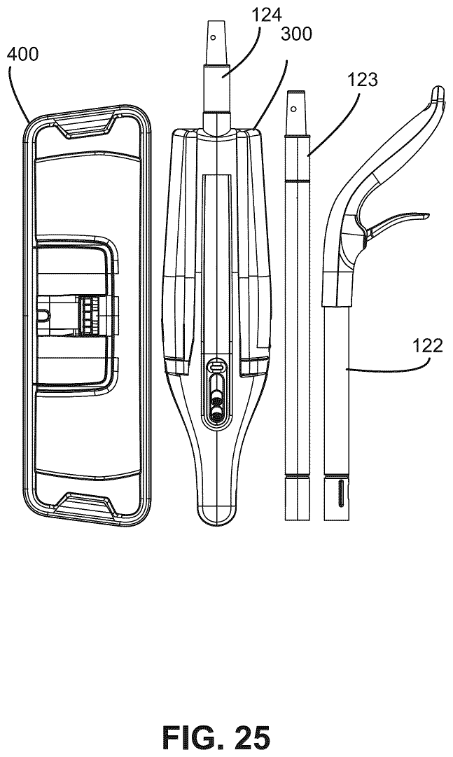

FIG. 25 depicts the mop 100 in a disassembled embodiment. In certain examples, the disassembled state shown in FIG. 25 may be similar to how the mop 100 is sold and packaged on a store shelf. In other embodiments, the mop 100 may be sold fully assembled. In some embodiments, the mop head 400/450 may be removed and sold separately, or sold as a replacement part. In certain examples, as shown, the mop head 400/450 may further include the mop pad 600. In other examples, the mop pad 600 is sold separately. In certain examples, the bottle assembly 200 may also be removed from the disassembled mop 100, and either kept with the kit, and/or sold as a replacement component for users who wish to replace the bottle assembly 200 rather than refill the bottle assembly 200.

The present disclosure relates to a method of using the disclosed mop. In certain examples, the mop 100 is assembled by connecting the three sections (122, 123, and 124) using the connector piece 130 at joint 127, 128 of the support assembly 120. In certain examples, once the support assembly 120 is assembled, the bottle assembly 200 can be secured in the bottle seat assembly 300.

To secure the bottle assembly 200 in the bottle seat assembly, the storage cap on bottle is removed, the bottle is oriented so that the quarter-turn bottle cap is facing down. In certain examples, the bottle assembly 200 is placed in the bottle seat assembly 300 so that the quarter-turn bottle cap 226 engages with the recess 302 to secure the bottle assembly 200 and open a valve 213.

To dispense treatment composition onto the floor, the trigger 112 is actuated, depressing the pump piston, pushing the liquid inside the chamber 234 through one or more nozzles 211 onto the floor in front of the mophead 400/500. In certain examples, releasing the trigger 112 allows the spring 232 to expand, raising the pump piston, and drawing the treatment composition from the bottle assembly 200 through the valve 213 and a liquid delivery system 208 into the chamber 234. The nozzle 211 may optionally include multiple nozzles. In certain examples, the switch 212 on the front of the bottle seat assembly 300 can be moved to select the desired nozzle.

To remove the bottle assembly 200, the back of the bottle seat assembly 300 features a release member 206 that releases the bottle assembly 200 from the bottle seat assembly 300. In certain examples, the release member 206 is pushed up, unlocking the bottle assembly 200 from the bottle seat assembly 300. In certain examples, the bottle assembly 200 may be discarded or refilled, and a new bottle may be positioned in the bottle seat assembly.

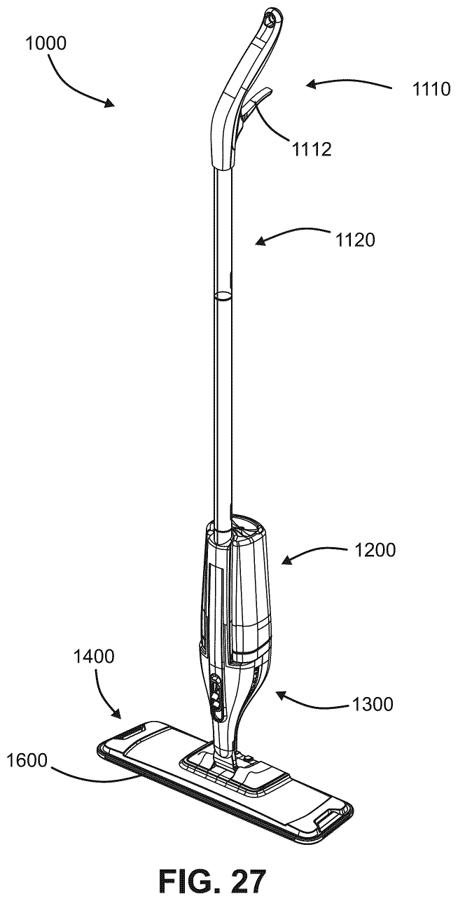

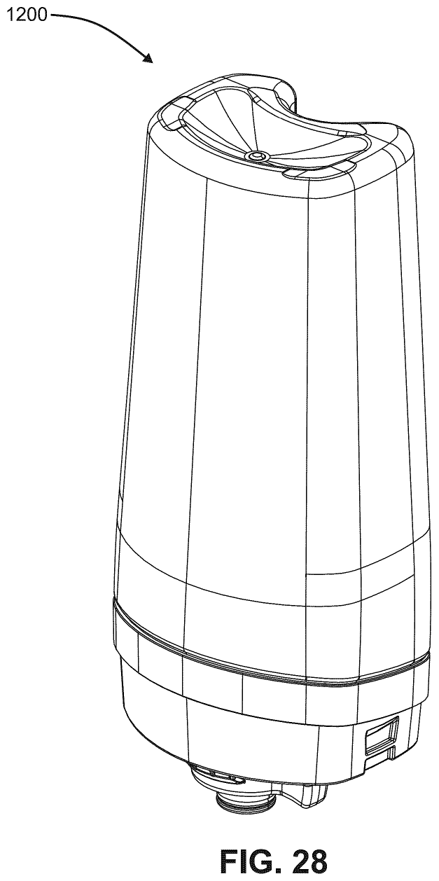

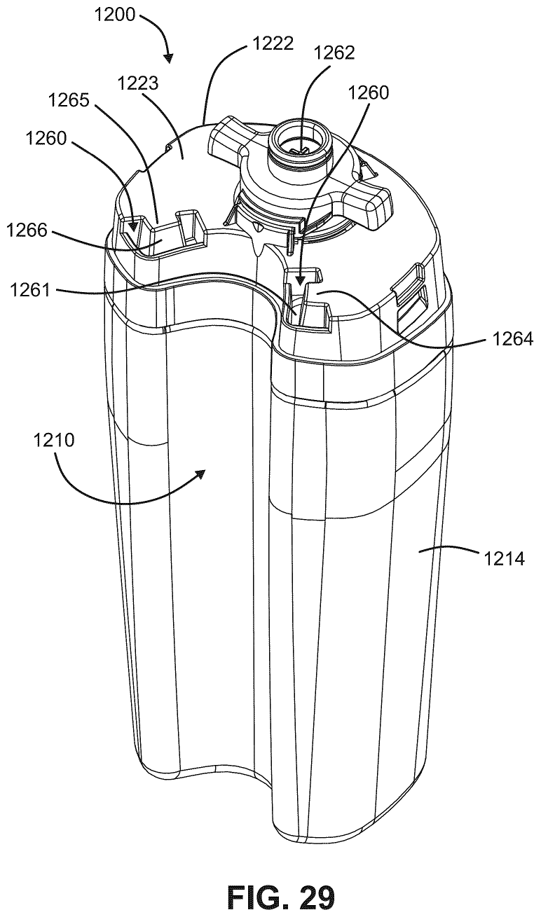

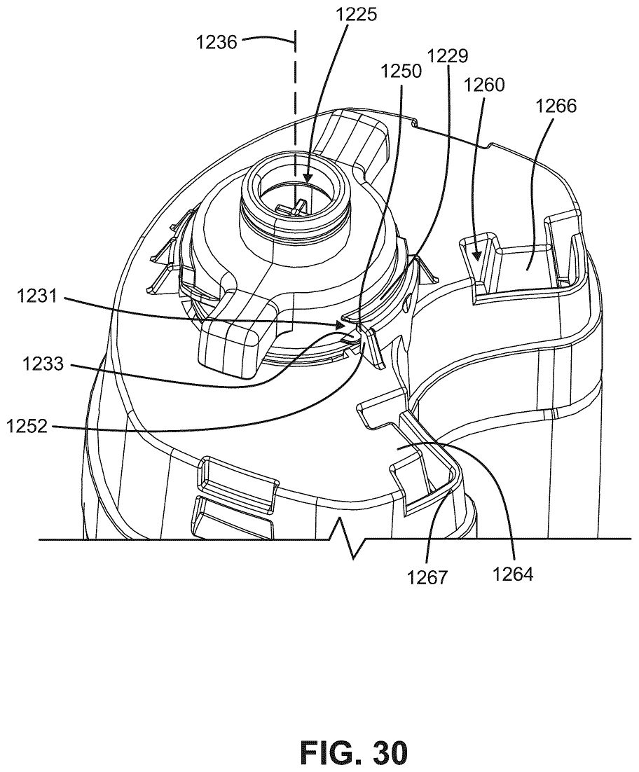

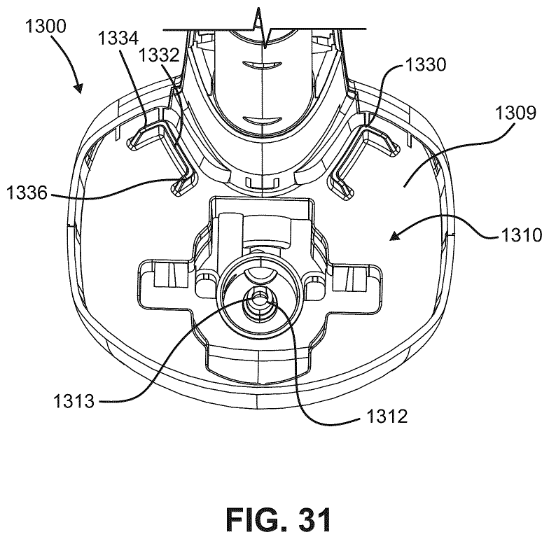

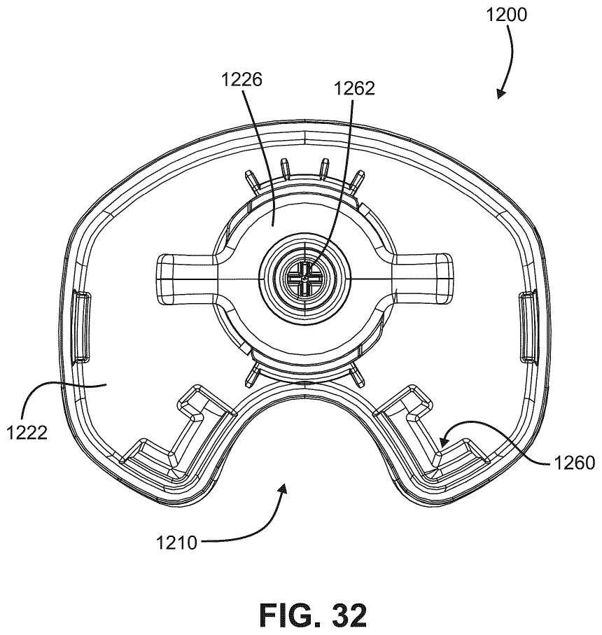

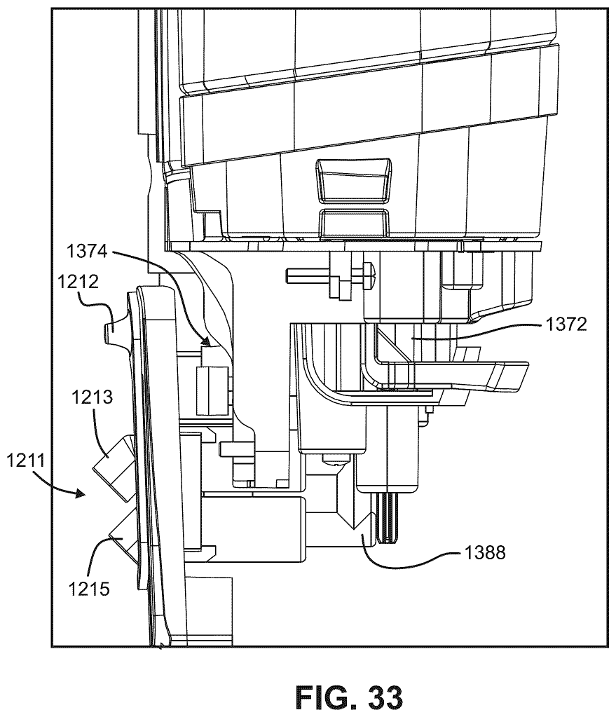

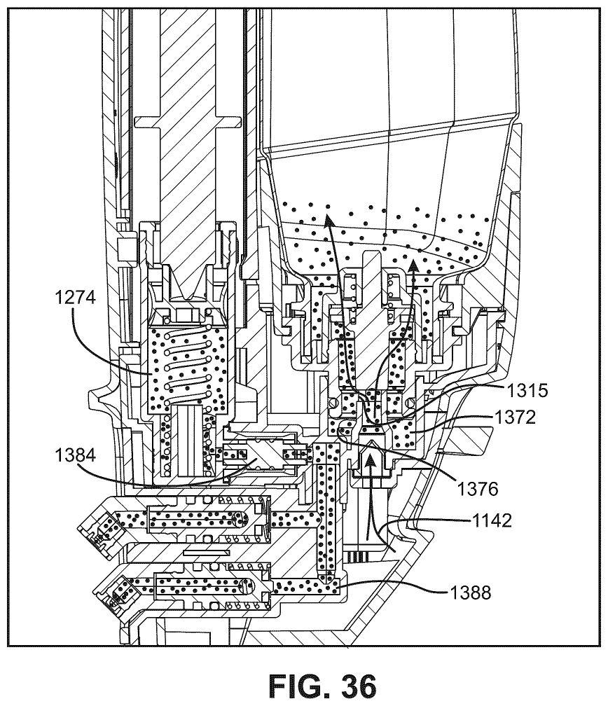

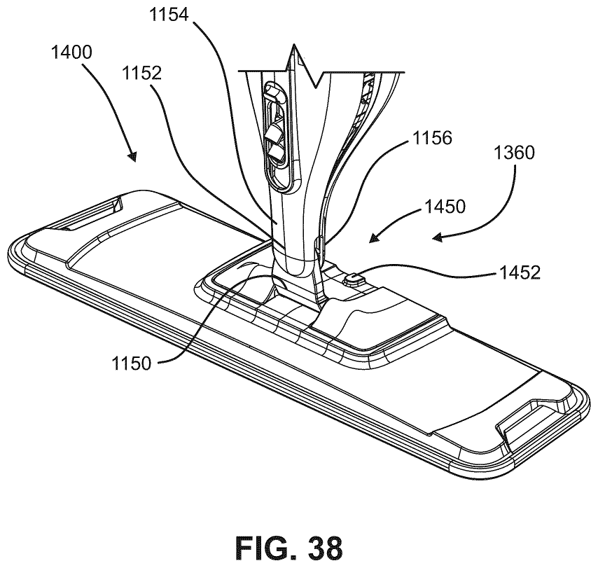

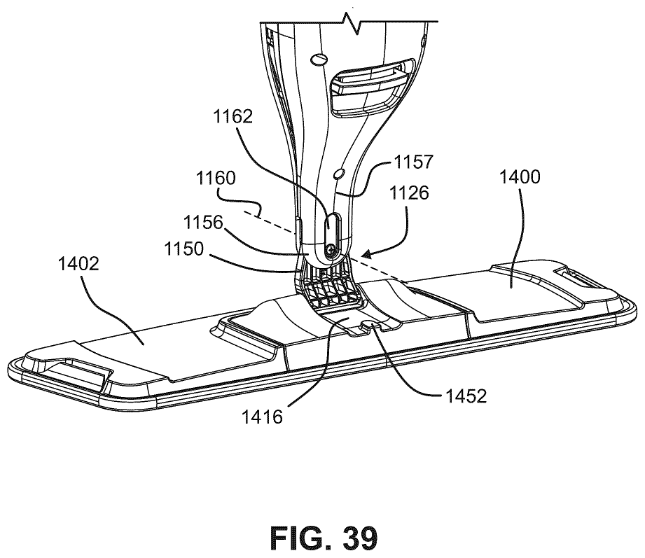

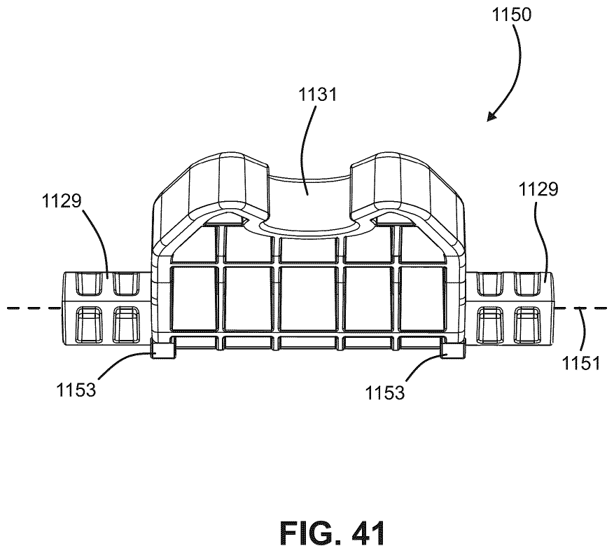

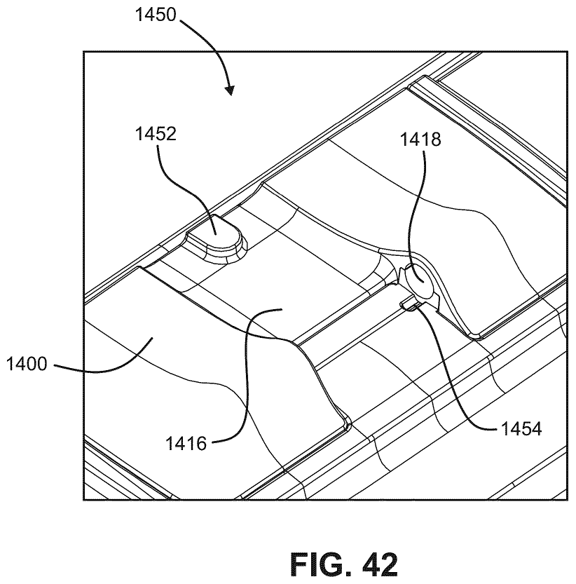

FIGS. 27-42 show various aspects of another example mop 1000. The mop 1000 shares many similarities with the mop 100. For conciseness, only certain aspects of the mop 1000 are described below. It should be appreciated that many aspects of the mop 100 apply to the mop 1000.

In certain examples, the mop 1000 includes a handle 1110, a support assembly 1120, a bottle assembly 1200, a bottle seat assembly 1300, a mop head 1400, and a mop pad 1600. In certain examples, the handle 1110 includes at least many of the same structural features as described above with respect to the handle 110. In certain examples, the support assembly 1120 includes at least many of the same structural features described above with respect to the support assembly 120. In certain examples, the mop pad 1600 includes any of the features described above with respect to the mop pads 600, 700.

In certain examples, the bottle assembly includes a bottle 1214, an attachment 1222, a bottle cap 1226, and a valve assembly 1225. In certain examples, the bottle assembly 1200 further includes a storage cap (not shown), like storage cap 204. In certain examples, the attachment 1222 includes a plurality of support pockets 1260. In certain examples, the plurality of support pockets 1260 are designed to interface with corresponding protrusions on the bottle seat assembly 1300. In certain examples, the plurality of support pockets 1260 are designed to position a gap 1210 of the bottle assembly 1200 in close contact (or near contact) with a portion of the support assembly 1120. In certain examples, the plurality of support pockets 1260 is two support pockets 1260. In certain examples, the two support pockets 1260 are positioned on opposite sides of the gap 1210. In certain examples, the plurality of support pockets 1260 each define a cavity 1261 that is generally C-shaped. In certain examples, the C-shaped cavity 1261 is defined around a primary lobe 1264. In certain examples, a top 1265 of the primary lobe is defined by a portion of a first surface 1223 of the attachment 1222. In certain examples, the primary lobe 1264 defines a tapered surface 1266 that increase with increasing depth of the cavity 1261. In certain examples, the plurality of support pockets 1260 each include an outer wall 1267 that defines a portion of an edge of the attachment 1222. In certain examples, the outer wall 1267 is shaped to follow a contour of the gap 1210.

In certain examples, the attachment 1222 includes at least one retaining feature 1252. In certain examples, the retaining feature 1252 is designed to engage and retain the bottle cap 1226. In certain examples, the attachment 1222 includes two retaining features 1252. In certain examples, the two retaining features 1252 are positioned on opposite sides of the bottle cap 1226. In certain examples, each retaining feature 1252 includes a ledge 1250. In certain examples, the ledge 1250 contacts the bottle cap 1226.

In certain examples, the bottle cap 1226 includes at least one bottle engagement feature 1229 that is designed to interface with the at least one retaining feature 1252 of the attachment 1222. In certain examples, the bottle cap 1226 includes two bottle engagement features 1229. In certain examples, the engagement feature 1229 defines a channel 1231 that is designed to receive the ledge 1250. In certain examples, the channel 1231 defines a sloped entry region 1233 to facilitate engagement with the ledge 1250 when the bottle cap 1226 is being attached to the attachment 1222. In certain examples, the bottle cap 1226 is designed to attach/detach by rotating about a bottle axis 1238. In certain examples, the bottle cap 1226 is attaches/detaches by rotating 90 degrees (quarter turn) about the bottle axis 1236 when the bottle cap 1226 is positioned adjacent the attachment 1222 and centered on the bottle axis 1236.

In certain examples, the valve assembly 1225 defines a seal 1263 defined around a rod 1262. In certain examples, the rod 1262 is movable between an open state and a sealed state. In certain examples, the rod 1262 is spring biased toward an end of the bottle assembly 1200 such that the seal 1263 is pressed against an interior rim 1268 of the bottle cap 1226, in the sealed state. When the bottle assembly 1200 is mounted to the bottle seat assembly 1300, the rod 1262 is in the open state such that liquid from the bottle 1214 is able to flow into the bottle seat assembly 1300.

In certain examples, the bottle seat assembly 1300 defines a bottle interface region 1310, a support interface region 1350, and a mop head interface region 1360. In certain examples, the bottle interface region 1310 includes a plurality of bottle positioning protrusions 1330 that are designed to engage the corresponding plurality of support pockets 1260. In certain examples, the bottle positioning protrusions 1330 define walls that extend upwardly from a seat surface 1309. In certain examples, the positioning protrusions 1330 define a C-shaped wall structure. In certain examples, the positioning protrusions 1330 include a primary wall 1332 connected at one end by a secondary wall 1334 and at the other end by a tertiary wall 1336. In certain examples, the secondary wall 1334 and the tertiary wall 1336 extend in parallel, offset by a length of the primary wall 1332. In certain examples, the primary wall is longer than the secondary wall 1334 and the tertiary wall 1336. In certain examples, the secondary wall 1334 is longer than the tertiary wall 1336. In certain examples, the primary wall 1332 extends along a path that is tangent to a circumference defined around the support assembly 1120.

In certain examples, the interaction between the positioning protrusions 1330 and the support pockets 1260 prevent movement about a plane that is generally normal to the bottle axis 1236. In certain examples, the tapered surface 1266 ensures that the bottle assembly 1200 is pulled tight into the desired position with the support assembly 1120 as the bottle assembly seats into the bottle seat assembly 1300.

In certain examples, the bottle seat assembly 1300 defines a liquid delivery system 1308 that transfers liquid from the bottle 1214 out through a plurality of nozzles 1211. In certain examples, the liquid delivery system 1308 interfaces with valve assembly 1225 of the bottle assembly 1200. In certain examples, a liquid reservoir 1370 includes a first chamber 1372, a second chamber 1374, a bottle interface 1312, a nozzle chamber 1388, and the plurality of nozzles 1211.

In certain examples, the first chamber 1372 is positioned directly below, and/or around certain portions of the bottle assembly 1200. In certain examples, the first chamber is directly fluidically connected to the bottle 1214. In certain examples, at least a portion of the bottle cap 1226 extends into the first chamber 1372.

In certain examples, the second chamber 1374 is adjacent the first chamber 1372. In certain examples, the second chamber 1374 is fluidically connected to the first chamber 1372. In certain examples, the second chamber is fluidically connected to the nozzle chamber 1388. In certain examples, the second chamber 1374 is downstream of the first chamber 1372, meaning that fluid from the bottle 1214 flows through the first chamber 1372 before arriving at the second chamber 1374.

In certain examples, the second chamber 1374 houses a plunger 1380. In certain examples, the plunger 1380 is movable within the second chamber 1374. In certain examples, a fluid volume within the second chamber 1374 changes with the position of the plunger 1380. In certain examples, the second chamber defines a lower plunger stop 1375 and an upper plunger stop 1373. In certain examples, the lower plunger stop 1375 defines a lower limit for the plunger 1380 such that when the plunger 1380 contacts the lower plunger stop 1375, the fluid volume within the second chamber 1374 is at a minimum. When the plunger 1380 is at the lower plunger stop 1375, a fluid volume remains in the second chamber 1374 such that any air within the second chamber 1374 does not pass through a second fluid pathway 1378 into the nozzle chamber 1388. In certain examples, the upper plunger stop 1373 defines an upper limit for the plunger 1380 such that when the plunger 1380 contacts the upper plunger stop 1373, the fluid volume within the second chamber 1374 is at a maximum.

In certain examples, the first and second chambers 1372, 1374 are connected by a first fluid pathway 1376. In certain examples, the first fluid pathway 1376 extends laterally between the first and second chambers 1372, 1374. In certain examples, a first fluid valve 1382 is positioned within/or adjacent to the first fluid pathway 1376 such that fluid is able to flow from the first chamber 1372 into the second chamber 1374, but not from the second chamber 1374 into the first chamber 1372.

In certain examples, the nozzle chamber 1388 is downstream of the second chamber, meaning that fluid from the bottle 1214 flows through the second chamber 1374 before arriving at the nozzle chamber 1388. In certain examples, the nozzle chamber 1388 defines a first branch 1387 and a second branch 1389. In certain examples, the first branch 1387 leads to a first nozzle 1213 of the plurality of nozzles 1211. In certain examples, the second branch 1389 leads to a second nozzle 1215 of the plurality of nozzles 1211. In certain examples, at least a majority of the nozzle chamber 1388 is positioned below the second chamber 1374.

In certain examples, the second chamber 1374 and the nozzle chamber 1388 are connected by a second fluid pathway 1378. In certain examples, the second fluid pathway 1378 extends laterally between the second chamber 1374 and the nozzle chamber 1388. In certain examples, a second fluid valve 1384 is positioned within/or adjacent to the second fluid pathway 1378 such that fluid is able to flow from the second chamber 1374 into the nozzle chamber 1388, but not vice-versa. In certain examples, the first fluid pathway and the second fluid pathway 1378 are positioned in parallel. In certain examples, the first fluid pathway 1376 and the second fluid pathway 1378 are positioned in parallel with fluid flow moving in opposite directions.

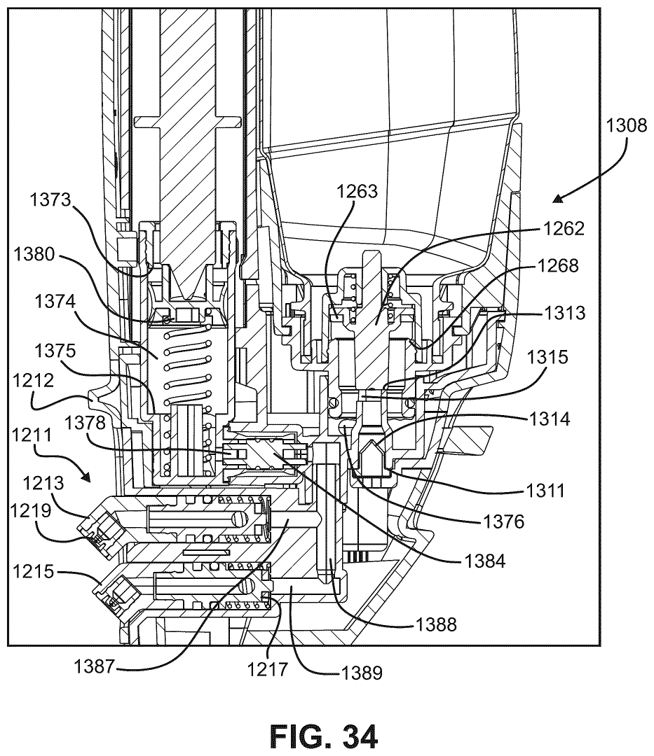

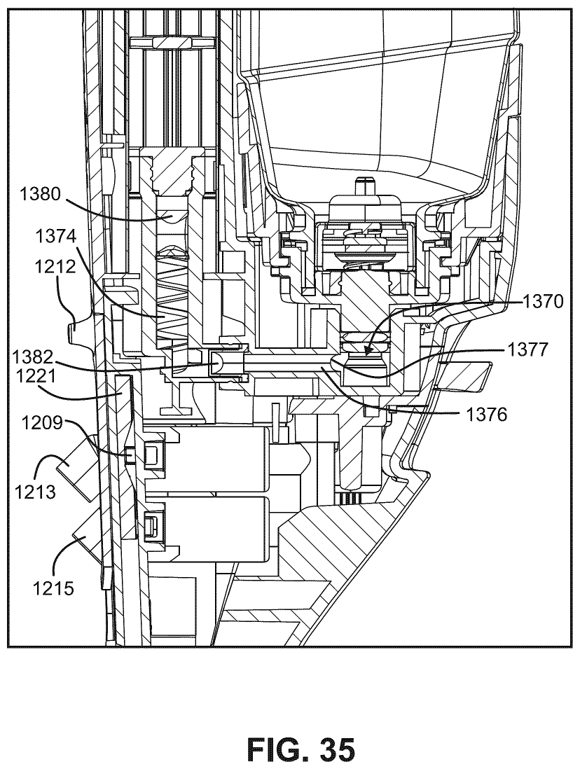

In certain examples, the first and second nozzles 1213, 1215 are separately operable. In certain examples, a switch 1212 controls operation of the plurality of nozzles 1211. In certain examples, the switch 1212 is a knob that can be toggled between an upper position and a lower position. In certain examples, the plurality of nozzles 1211 each include a spring biased seal 1217. In certain examples, the plurality of nozzles 1211 are biased toward being open and operable. In certain examples, the switch 1212 moves a cam 1221 that slides between the first and second nozzles 1213, 1215. In certain examples, the cam 1221 engages a toggle portion 1209 of either respective nozzle 1213, 1215 to slide the seal 1217 between a sealed state and the open state. When the switch is in the upper position, the cam is at, or centered around, the first nozzle 1213. When the switch is in the lower position, the cam is at, or centered around, the second nozzle 1215. As shown on FIGS. 34 and 35, the first nozzle 1213 is in the open state and the second nozzle 1215 is in the closed state. In certain examples, each of the plurality of nozzles include a nozzle valve 1219 at a tip of the nozzles 1211.

In certain examples, the bottle interface 1312 is a fixed portion of the liquid delivery system that depresses (open state) the rod 1262 when the bottle assembly 1200 is connected to the bottle seat assembly 1300. When the rod 1262 is depressed, the liquid reservoir 1370 within the bottle seat assembly 1300 is filled with liquid from the bottle 1214. When the bottle assembly 1200 is first placed onto the bottle seat assembly 1300, air inside the liquid reservoir 1370 travels upward into the bottle as liquid travels into the liquid reservoir 1370.

In certain examples, the bottle interface 1312 defines an air inlet end 1311 and an air outlet end 1313. In certain examples, the bottle interface 1312 defines a hollow cavity extending between the air inlet end 1311 and the air outlet end 1313. In certain examples, an air valve 1314 is positioned within the cavity of the bottle interface 1312. In certain examples, the air valve 1314 is adjacent the air inlet end 1311. In certain examples, the air outlet end 1313 is adjacent the valve assembly 1225. In certain examples, an air outlet opening 1315 is defined adjacent the air outlet end 1313. In certain examples, the air valve 1314 is a one-way valve that allows air to flow into the bottle in response to a pressure drop within the bottle assembly 1200 caused by fluid exiting the plurality of nozzles 1211.

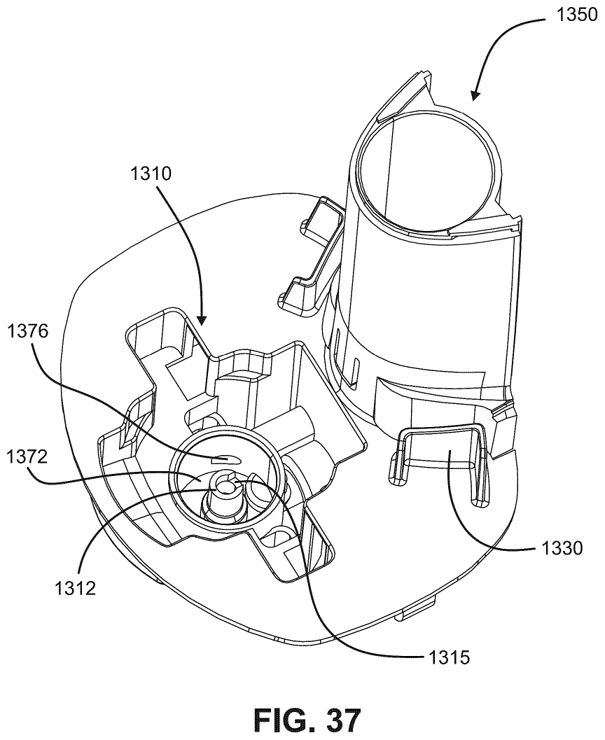

In certain examples, the air outlet opening 1315 is positioned above the first fluid pathway 1376. In certain examples, an inlet 1377 of the first fluid pathway 1376 and the air outlet opening 1315 are both positioned within the first chamber 1372. In certain examples, at least a portion of the liquid within the first chamber is positioned below the air outlet opening. In certain examples, an air pathway 1142 is defined that rises up from the air outlet opening and into a top portion of the bottle 1214. In certain examples, by positioning the air outlet opening 1315 above the first fluid pathway 1376, the air pathway 1142 avoids intermixing with fluid flowing from the first chamber 1372 to the second chamber 1374. In certain examples, the air outlet opening 1315 remains horizontally above the first fluid pathway 1376 when the support assembly and connected components are held at an angle during use. In certain examples, the air outlet opening 1315 is positioned a distance above the first fluid pathway 1376, where the distance is sufficient to enable the air outlet opening 1315 to remain above the first fluid pathway when the mop 1000 is at an angle between 0-80 degrees from vertical. In certain examples, the first fluid pathway 1376 and the bottle interface 1312 are integrally connected, as shown in FIG. 37. In certain examples, the bottle interface 1312 and the first fluid pathway 1376 are unitarily formed from a single component of the liquid delivery system 1308.

In operation, in certain examples, the liquid delivery system 1308 functions by moving liquid from the bottle 1214 and out through the plurality of nozzles 1211. In certain examples, fluid flow is generated by movement of the plunger 1380. In certain examples, the plunger 1380 is linked to the handle 1110 such that movement of a trigger 1112 of the handle causes movement of the plunger 1380. When the trigger 1112 is pulled, the plunger 1380 moves from contacting the upper plunger stop 1373 to contacting the lower plunger stop 1375. As the plunger 1380 reduces the fluid volume of the second chamber 1374, fluid within the second chamber 1374 is forced through the second fluid pathway 1378 and out through the plurality of nozzles 1211. Fluid cannot go backwards through the first fluid pathway 1376 because of the first fluid valve 1382. When the trigger is released, the plunger moves back to the upper plunger stop 1373. As the plunger 1380 moves towards the upper plunger stop 1373, the fluid volume within the second chamber 1374 increases, thereby pulling fluid from the first chamber 1372 into the second chamber 1374 through the first fluid pathway 1376. Fluid is unable to move from the nozzle chamber 1388 into the second chamber 1374 because of the second fluid valve 1384. As fluid moves from the first chamber 1372 into the second chamber 1374, air moves through the air valve 1314 of the bottle interface 1312 and into the first chamber 1372, and eventually to the top of the bottle 1214, thereby normalizing pressure within the liquid delivery system 1308.

In certain examples, a joint 1126 connects the bottle seat assembly 1300 to the mop head 1400. In certain examples, the joint 1126 defines an upper portion 1152 and a lower portion 1150.

In certain examples, the upper portion 1152 defines a front portion 1154 and a rear portion 1156. In certain examples, the rear portion 1156 includes a post (not shown) that interfaces with the lower portion 1150. In certain examples, the lower portion 1150 is rotatable about a post axis 1160 that extends through the post from the rear portion 1156 towards the front portion 1154. In certain examples, the rotation of the lower portion 1150 about the post axis 1160 further enables rotation of the mop head 1400 about the post axis 1160. In certain examples, the lower portion 1150 is captured between the front portion 1154 and the rear portion 1156.

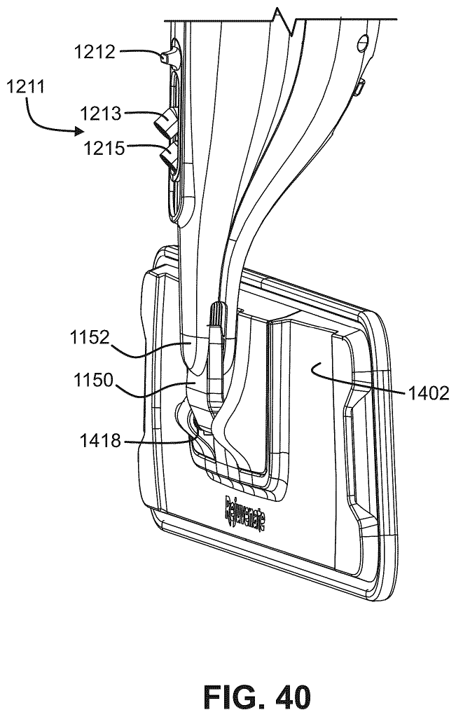

In certain examples, a rear face 1157 of the rear portion 1156 defines a storage pocket 1162 that is designed to interface with a corresponding feature of the mop head 1400 when the mop 1000 is in a storage position (as shown in FIG. 40). In certain examples, the storage pocket 1162 is elongate in the direction of the length of the support assembly 1120. In certain examples, a fastener is positioned within the storage pocket 1162. In certain examples, the fastener maintains connection between the front portion 1154 and the rear portion 1156 of the upper portion 1152 of the joint 1126. In certain examples, the storage pocket 1162 defines curved ends. In certain examples, the storage pocket 1162 defines semi-circular ends.

In certain examples, the lower portion 1150 defines a hole 1131 that engages the post of the upper portion 1152. In certain examples, the lower portion 1150 defines two pins 1126. In certain examples, the pins 1129 extend outward from opposite sides of the lower portion 1150. In certain examples, the pins 1129 extend laterally, normal to a length of the support assembly 1120. In certain examples, the pins 1129 engage the mop head 1400 and enable to mop to rotate about a pin axis 1151 that extends between the pins 1129. In certain examples, each of the pins 1129 include a locking protrusion 1153 that is designed to interface with a corresponding feature on the mop head when the mop head 1400 is in a storage position. In certain examples, there is one locking protrusion 1153 adjacent each pin 1129. In certain examples, the pin axis 1151 is normal to the post axis 1160.

In certain examples, the mop head 1400 defines a top surface 1402. In certain examples, the top surface 1402 defines a bottle seat engagement region 1450. In certain examples, the bottle seat engagement region 1450 is centrally positioned on the top surface 1402. In certain examples, the bottle seat engagement region 1450 defines a storage channel 1416. In certain examples, the storage channel 1416 is designed to interface with the joint 1126 when the mop 1000 is in the storage position. In certain examples, the bottle seat engagement region 1450 further defines a storage ridge 1452. In certain examples, the storage ridge 1452 is positioned at a base of the storage channel 1416. In certain examples, the bottle seat engagement region 1450 further defines two pin cavities 1418 that are designed to receive the pins 1129. In certain examples, the bottle seat engagement region 1450 further defines a locking cavity 1454 that is designed to receive the locking protrusion 1153 when the mop 1000 is in the storage position. In certain examples, there is one locking cavity 1454 adjacent each pin cavity 1418.

As shown on FIG. 40, when the mop 1000 is in the storage position, the mop head 1400 is rotated such that the mop head 1400 contacts the bottle seat assembly along at least two points, where at least one of the at least two points is rear of the pin axis 1151. In certain examples, in the storage position, the locking protrusions 1153 engage the locking cavities 1454 such that the mop head 1400 cannot rotate about the pin axis 1151 without intentional force applied to the mop head 1400. In certain examples, the storage ridge 1452 engages the storage pocket 1162 such that the mop head 1400 cannot rotate about the post axis 1160. In certain examples, a method of storing the mop 1000 includes rotating the mop head 1400 until the storage ridge 1452 engages the storage pocket 1162 and the locking protrusions 1153 engage the locking cavities 1454.

From the forgoing detailed description, it will be evident that modifications and variations can be made in the aspects of the disclosure without departing from the spirit or scope of the aspects. While the best modes for carrying out the many aspects of the present teachings have been described in detail, those familiar with the art to which these teachings relate will recognize various alternative aspects for practicing the present teachings that are within the scope of the appended claims.

Aspects of the present disclosure include:
Aspect 1. A mop comprising:
   a. a handle having a trigger;
   b. a support assembly connected to the handle;
   c. a bottle seat assembly mounted to the support assembly;
   d. a mop head connected to the bottle seat assembly via a joint; and
   e. a mop pad removably attached to the mop head.
Aspect 2. The mop of Aspect 1, wherein the handle further comprises an aperture for hanging the mop.
Aspect 3. The mop of any of Aspects 1-2, wherein the support assembly comprises:
   a. a first portion;
   b. a second portion;
   c. a third portion; and
   d. a connector having female and male coupling components for connecting the first, second, and third portions.
Aspect 4. The mop of any of Aspects 1-3, wherein the joint enables rotation of the mop head about a first axis and a second axis, wherein the first and second axes are normal to each other.
Aspect 5. The mop of any of Aspects 1-4, wherein the mop head further comprises a channel for storing the mop.
Aspect 6. The mop of any of Aspects 1-5, wherein the mop head comprises:
   a. a top side;
   b. a bottom side;
   c. first and second transverse sides; and
   d. first and second lateral sides.
Aspect 7. The mop of any of Aspects 1-6, wherein the mop pad comprises tabs positioned along edges of the mop pad.
Aspect 8. The mop of any of Aspects 1-7, wherein the mop head comprises a flexible scrubber portion configured to remove difficult-to-clean soils.
Aspect 9. The mop of Aspect 7, wherein the mop head further comprises cutouts configured to receive tabs of the mop pad.
Aspect 10. The mop of Aspect 7, wherein the mop pad is selected from:
   a. a single-use disposable pad; and
   b. a reusable washable pad.
Aspect 11. The mop of any of Aspects 1-10, wherein the mop pad comprises a flexible scrubber portion integrated into the mop pad.
Aspect 12. The mop of any of Aspects 1-11, wherein the bottle seat assembly comprises:
   a. a recess for receiving a bottle;
   b. a pump mechanism actuated by the trigger; and
   c. a nozzle.
Aspect 13. A mop pad comprising:
   a. a first side;
   b. a second side; and
   c. a tab positioned along an edge of the second side for removal from a mop head.
Aspect 14. The mop pad of Aspect 13, wherein the mop pad is constructed from materials selected from the group consisting of non-woven fiber, microfiber, abrasive material, and combinations thereof.
Aspect 15. The mop pad of any of Aspects 13-14, wherein the tab is circular in shape.
Aspect 16. The mop pad of any of Aspects 13-14, wherein the tab is triangular in shape.
Aspect 17. The mop pad of any of Aspects 13-14, wherein the tab is rectangular in shape.
Aspect 18. A mop head comprising:
   a. a top side;
   b. a bottom side;
   c. transverse sides;
   d. lateral sides; and
   e. cutouts configured to receive tabs of a mop pad.
Aspect 19. The mop head of Aspect 18, further comprising a hinged portion configured to be selectively depressed.
Aspect 20. The mop head of Aspect 19, further comprising a flexible scrubber portion configured to remove difficult-to-clean soils.
Aspect 21. The mop head of any of Aspects 18-20, wherein the cutouts are circular in shape.
Aspect 22. The mop pad of any of Aspects 18-21, wherein the cutouts are triangular in shape.
Aspect 23. The mop pad of any of Aspects 18-22, wherein the cutouts are rectangular in shape.
Aspect 24. The mop head of any of Aspects 18-23, further comprising a channel on the top side of the mop head.
Aspect 25. A method of cleaning a floor surface comprising:
   a. actuating a trigger on a mop handle to dispense cleaning chemistry through a liquid delivery system;
   b. moving a mop head with a mop pad comprising a tab over the floor surface to remove soil to form a soiled mop pad; and
   c. removing the soiled mop pad from the mop head using the tab.
Aspect 26. The method of Aspect 25, further comprising selectively engaging a flexible scrubber portion to remove difficult-to-clean soils from the floor surface.
Aspect 27. A modular support assembly for a mop comprising:
   a. a first portion;
   b. a second portion;
   c. a third portion;
   d. an internal rod mechanism; and
   e. a connector having:
      i. a female coupling component; and
      ii. a male coupling component configured to engage with the female coupling component.
Aspect 28. The modular support assembly of Aspect 27, wherein the female coupling component and the male coupling component are configured to provide secure connection between the first portion and the second portion.
Aspect 29. The modular support assembly of any of Aspects 27-28,wherein the connector is configured to enable separation of the first portion and second portion for storage.
Aspect 30. The modular support assembly of any of Aspects 27-29,wherein the female coupling component and male coupling component are configured to ensure proper alignment during assembly.
Aspect 31. The modular support assembly of any of Aspects 27-30,further comprising:
   a. a handle connected to the first portion; and
   b. a bottle seat assembly connected to the third portion.
Aspect 32. The modular support assembly of Aspect 31, wherein the handle includes a trigger for actuating a liquid delivery system.
Aspect 33. A bottle assembly for a mop comprising:
   a. a body;
   b. a bottom;
   c. a top;
   d. a shoulder;
   e. a neck;
   f. an opening;
   g. a quarter-turn cap secured on the top of the bottle assembly.
Aspect 34. The bottle of Aspect 33, further comprising a storage cap.
Aspect 35. A method of securing a bottle to a mop, the method comprising:
   a. removing a storage cap from a bottle to expose a quarter-turn bottle cap;
   b. orienting the bottle to face downwards;
   c. inserting the quarter-turn bottle cap into a bottle seat assembly of a mop; and
   d. pressing straight down along a long axis of the bottle to lock the bottle into the bottle seat assembly.

Aspect 36. The method of Aspect 35, wherein removing the bottle involves lifting a lever on a back side of the bottle seat assembly allowing the bottle to be removed.
Aspect 37. A mop comprising:
   a. a handle;
   b. a support assembly connected to the handle;
   c. a bottle seat assembly mounted to the support assembly and configured to receive a bottle assembly, the bottle seat assembly comprising:
   d. a liquid reservoir defining:
      i. a first chamber configured to receive liquid from the bottle assembly;
      ii. a second chamber fluidically connected to the first chamber;
      iii. a first fluid pathway extending between the first chamber and the second chamber, the first fluid pathway having an inlet positioned within the first chamber; and
      iv. a bottle interface defining an air outlet opening, wherein the air outlet opening is positioned above the first fluid pathway;
e. a plurality of nozzles fluidically connected to the liquid reservoir; and
f. a mop head connected to the bottle seat assembly.

Aspect 38. The mop of Aspect 37, wherein the first fluid pathway includes a first fluid valve configured to allow fluid flow from the first chamber into the second chamber but not from the second chamber into the first chamber.

Aspect 39. The mop of any of Aspects 37-38, wherein the second chamber houses a plunger movable within the second chamber, wherein movement of the plunger changes a fluid volume within the second chamber.

Aspect 40. The mop of any of Aspects 37-39, wherein the second chamber defines a lower plunger stop and an upper plunger stop that limit movement of the plunger.
Aspect 41. The mop of any of Aspects 37-40, wherein the plunger is linked to a trigger on the handle such that actuation of the trigger causes movement of the plunger.
Aspect 42. The mop of any of Aspects 37-41, wherein the liquid reservoir further defines a nozzle chamber fluidically connected to the second chamber and positioned downstream of the second chamber.
Aspect 43. The mop of any of Aspects 37-42, further comprising a second fluid pathway extending between the second chamber and the nozzle chamber, the second fluid pathway including a second fluid valve configured to allow fluid flow from the second chamber into the nozzle chamber but not from the nozzle chamber into the second chamber.
Aspect 44. The mop of any of Aspects 37-43, wherein the first fluid pathway and the second fluid pathway are positioned in parallel with fluid flow moving in opposite directions.
Aspect 45. The mop of any of Aspects 37-44, wherein the bottle interface defines an air inlet end and an air outlet end and includes an air valve positioned within a cavity of the bottle interface configured to allow air flow into the bottle assembly.
Aspect 46. The mop of any of Aspects 37-45, wherein the bottle interface and the first fluid pathway are integrally connected and unitarily formed from a single component of a liquid delivery system.
Aspect 47. A mop comprising:
   a. a handle;
   b. a support assembly connected to the handle;
   c. a mop head defining a top surface, the top surface defining a bottle seat engagement region centrally positioned on the top surface, the bottle seat engagement region including two pin cavities, a storage channel, a storage ridge, and a locking cavity adjacent each pin cavity, the storage ridge being positioned at a base of the storage channel; and
   d. a bottle seat assembly mounted to the support assembly and mounted to the mop head, the bottle seat assembly including a joint connecting the bottle seat assembly to a mop head, the joint including an upper portion and a lower portion, the upper portion defining a post extending outward from the upper portion and defining a post axis, the upper portion defining a rear face with a storage pocket, the lower portion pivotably connecting to the post, the lower portion being rotatable about the post axis, the lower portion including two pins extending laterally from opposite sides and defining a pin axis normal to the post axis, the lower portion defining a locking protrusion adjacent each pin;
e. wherein, in a storage position, the mop head is rotated such that the locking protrusions engage the locking cavities to prevent rotation about the pin axis, and the storage ridge engages the storage pocket to prevent rotation about the post axis.
Aspect 48. The mop of Aspect 47, wherein when in the storage position, the mop head contacts the bottle seat assembly in at least two points where at least one point is rear of the pin axis.
Aspect 49. The mop of any of Aspects 47-48, wherein the locking protrusions each include features configured to engage the locking cavities such that intentional force is required to rotate the mop head out of the storage position.
Aspect 50. The mop of any of Aspects 47-49, wherein the two pins extend laterally normal to a length of the support assembly.
Aspect 51. The mop of any of Aspects 47-50, wherein the lower portion defines a hole configured to engage the post of the upper portion.
Aspect 52. The mop of any of Aspects 47-51, wherein the upper portion of the joint comprises a front portion and a rear portion, and the lower portion is captured between the front portion and the rear portion.
Aspect 53. The mop of any of Aspects 47-52, wherein the storage pocket defines curved ends, and wherein the storage pocket is elongate in a direction of a length of the support assembly.
Aspect 54. A mop comprising:
   a. a handle;
   b. a support assembly connected to the handle; and
   c. a bottle seat assembly mounted to the support assembly and configured to receive a bottle assembly, the bottle seat assembly comprising:
      i. a liquid reservoir configured to receive liquid from a bottle assembly;
      ii. a first nozzle and a second nozzle both fluidically connected to the liquid reservoir, each of the first and second nozzles including a seal movable between an open state and a sealed state, the seal biased toward an open state, the first and second nozzles defining a toggle portion; and
      iii. a switch being accessible by a user, the switch controlling a cam, the cam being movable between the first nozzle and the second nozzle, the cam engaging the toggle portion of both the first and second nozzles, wherein when the switch is in a lower position, the cam is centered at the second nozzle such that the second nozzle is in the open state, wherein when the switch is in an upper position, the cam is centered at the first nozzle such that the first nozzle is in the open state.
Aspect 55. The mop of Aspect 54, wherein the switch is a knob that can be toggled between the upper position and the lower position.
Aspect 56. The mop of any of Aspects 54-55, wherein each of the first and second nozzles include a spring biased seal that biases the seal toward the open state.
Aspect 57. The mop of any of Aspects 54-56, wherein the cam slides between the first and second nozzles as the switch moves between the upper position and the lower position.
Aspect 58. The mop of any of Aspects 54-57, wherein the cam engages the toggle portion of a respective nozzle to slide the seal between the sealed state and the open state.
Aspect 59. The mop of any of Aspects 54-58, wherein when the cam is centered at the first nozzle in the upper position, the second nozzle is in the sealed state, and when the cam is centered at the second nozzle in the lower position, the first nozzle is in the sealed state.
Aspect 60. The mop of any of Aspects 54-59, wherein each of the plurality of nozzles includes a nozzle valve at a tip of the nozzles.
Aspect 61. A spray mop comprising:
   a. a handle;
   b. a support assembly connected to the handle;
   c. a bottle assembly including a plurality of support pockets, the plurality of support pockets each defining a cavity, the cavity defining a primary lobe with a tapered surface that increases with increasing depth of the cavity;
   d. a bottle seat assembly mounted to the support assembly, the bottle seat assembly defining a bottle interface region including a seat surface configured to receive the bottle assembly, the bottle interface region defining a plurality of bottle positioning protrusions extending upwardly from the seat surface, each bottle positioning protrusion defining a wall structure including a primary wall, wherein the primary wall extends along a path that is tangent to a circumference defined around the support assembly; and
   e. a mop head connected to the bottle seat assembly;
   f. wherein the plurality of bottle positioning protrusions are configured to engage the corresponding plurality of support pockets on the bottle assembly such that interaction between the plurality of positioning protrusions and the corresponding plurality of support pockets prevents movement of the bottle assembly in a plane generally normal to a bottle axis, and wherein the interaction between the plurality of positioning protrusions and the corresponding plurality of support pockets positions the bottle assembly into a desired position adjacent the support assembly when the bottle assembly seats into the bottle seat assembly.
Aspect 62. The mop of Aspect 61, wherein the plurality of support pockets comprises two support pockets positioned on opposite sides of a gap in the bottle assembly.
Aspect 63. The mop of any of Aspects 61-62, wherein each support pocket of the plurality of support pockets defines a C-shaped cavity around the primary lobe.
Aspect 64. The mop of any of Aspects 61-63, wherein the tapered surface of the primary lobe is configured to pull the bottle assembly into the desired position as the bottle assembly seats into the bottle seat assembly.
Aspect 65. The mop of any of Aspects 61-64, wherein each support pocket further defines an outer wall that defines a portion of an edge of an attachment of the bottle assembly, the outer wall being shaped to follow a contour of a gap in the bottle assembly.
Aspect 66. The mop of any of Aspects 61-65, wherein the wall structure of each bottle positioning protrusion defines a C-shaped configuration including a secondary wall and a tertiary wall connected by the primary wall, wherein the primary wall is longer than both the secondary wall and the tertiary wall, and wherein the secondary wall and tertiary wall extend in parallel offset by a length of the primary wall.

What is claimed is:

1. A mop comprising:
a handle;
a support assembly connected to the handle;
a bottle seat assembly mounted to the support assembly and configured to receive a bottle assembly, the bottle seat assembly comprising:
a liquid reservoir defining:
a first chamber configured to receive liquid from the bottle assembly;
a second chamber fluidically connected to the first chamber;
a first fluid pathway extending between the first chamber and the second chamber, the first fluid pathway having an inlet positioned within the first chamber; and
a bottle interface defining an air outlet opening, wherein the air outlet opening is positioned above the first fluid pathway;
a plurality of nozzles fluidically connected to the liquid reservoir; and
a mop head connected to the bottle seat assembly.

2. The mop of claim 1, wherein the first fluid pathway includes a first fluid valve configured to allow fluid flow from the first chamber into the second chamber but not from the second chamber into the first chamber.

3. The mop of claim 1, wherein the second chamber houses a plunger movable within the second chamber, wherein movement of the plunger changes a fluid volume within the second chamber.

4. The mop of claim 3, wherein the second chamber defines a lower plunger stop and an upper plunger stop that limit movement of the plunger.

5. The mop of claim 3, wherein the plunger is linked to a trigger on the handle such that actuation of the trigger causes movement of the plunger.

6. The mop of claim 1, wherein the liquid reservoir further defines a nozzle chamber fluidically connected to the second chamber and positioned downstream of the second chamber.

7. The mop of claim 6, further comprising a second fluid pathway extending between the second chamber and the nozzle chamber, the second fluid pathway including a second fluid valve configured to allow fluid flow from the second chamber into the nozzle chamber but not from the nozzle chamber into the second chamber.

8. The mop of claim 7, wherein the first fluid pathway and the second fluid pathway are positioned in parallel with fluid flow moving in opposite directions.

9. The mop of claim 1, wherein the bottle interface defines an air inlet end and an air outlet end and includes an air valve positioned within a cavity of the bottle interface configured to allow air flow into the bottle assembly.

10. The mop of claim 1, wherein the bottle interface and the first fluid pathway are integrally connected and unitarily formed from a single component of a liquid delivery system.

11. A mop comprising:
a handle;
a support assembly connected to the handle;
a mop head defining a top surface, the top surface defining a bottle seat engagement region centrally positioned on the top surface, the bottle seat engagement region including two pin cavities, a storage channel, a storage ridge, and a locking cavity adjacent each pin cavity, the storage ridge being positioned at a base of the storage channel; and
a bottle seat assembly mounted to the support assembly and mounted to the mop head, the bottle seat assembly including a joint connecting the bottle seat assembly to the mop head, the joint including an upper portion and a lower portion, the upper portion defining a post extending outward from the upper portion and defining a post axis, the upper portion defining a rear face with a storage pocket, the lower portion pivotably connecting to the post, the lower portion being rotatable about the post axis, the lower portion including two pins extending laterally from opposite sides and defining a pin axis normal to the post axis, the lower portion defining a locking protrusion adjacent each pin;
wherein, in a storage position, the mop head is rotated such that the locking protrusions engage the locking cavities to prevent rotation about the pin axis, and the storage ridge engages the storage pocket to prevent rotation about the post axis.

12. The mop of claim 11, wherein when in the storage position, the mop head contacts the bottle seat assembly in at least two points where at least one point is rear of the pin axis.

13. The mop of claim 11, wherein the locking protrusions each include features configured to engage the locking cavities such that intentional force is required to rotate the mop head out of the storage position.

14. The mop of claim 11, wherein the two pins extend laterally normal to a length of the support assembly.

15. The mop of claim 11, wherein the lower portion defines a hole configured to engage the post of the upper portion.

16. The mop of claim 11, wherein the upper portion of the joint comprises a front portion and a rear portion, and the lower portion is captured between the front portion and the rear portion.

17. The mop of claim 11, wherein the storage pocket defines curved ends, and wherein the storage pocket is elongate in a direction of a length of the support assembly.

18. A mop comprising:
a handle;
a support assembly connected to the handle; and
a bottle seat assembly mounted to the support assembly and configured to receive a bottle assembly, the bottle seat assembly comprising:
a liquid reservoir configured to receive liquid from the bottle assembly;
a first nozzle and a second nozzle both fluidically connected to the liquid reservoir, each of the first and second nozzles including a seal movable between an open state and a sealed state, the seal biased toward the open state, the first and second nozzles defining a toggle portion; and
a switch being accessible by a user, the switch controlling a cam, the cam being movable between the first nozzle and the second nozzle, the cam engaging the toggle portion of both the first and second nozzles, wherein when the switch is in a lower position, the cam is centered at the second nozzle such that the second nozzle is in the open state, wherein when the switch is in an upper position, the cam is centered at the first nozzle such that the first nozzle is in the open state.

19. The mop of claim 18, wherein the switch is a knob that can be toggled between the upper position and the lower position.

20. The mop of claim 18, wherein each of the first and second nozzles includes a spring biased seal that biases the seal toward the open state.

21. The mop of claim 18, wherein the cam slides between the first and second nozzles as the switch moves between the upper position and the lower position.

22. The mop of claim 18, wherein the cam engages the toggle portion of a respective nozzle to slide the seal between the sealed state and the open state.

23. The mop of claim 18, wherein when the cam is centered at the first nozzle in the upper position, the second nozzle is in the sealed state, and when the cam is centered at the second nozzle in the lower position, the first nozzle is in the sealed state.

24. The mop of claim 18, wherein each of the nozzles includes a nozzle valve at a tip of the nozzles.

25. A spray mop comprising:
a handle;
a support assembly connected to the handle;
a bottle assembly including a plurality of support pockets, the plurality of support pockets each defining a cavity, the cavity defining a primary lobe with a tapered surface that increases with increasing depth of the cavity;
a bottle seat assembly mounted to the support assembly, the bottle seat assembly defining a bottle interface region including a seat surface configured to receive the bottle assembly, the bottle interface region defining a plurality of bottle positioning protrusions extending upwardly from the seat surface, each bottle positioning protrusion defining a wall structure including a primary wall, wherein the primary wall extends along a path that is tangent to a circumference defined around the support assembly; and
a mop head connected to the bottle seat assembly;
wherein the plurality of bottle positioning protrusions are configured to engage the corresponding plurality of support pockets on the bottle assembly such that interaction between the plurality of positioning protrusions and the corresponding plurality of support pockets prevents movement of the bottle assembly in a plane generally normal to a bottle axis, and wherein the interaction between the plurality of positioning protrusions and the corresponding plurality of support pockets positions the bottle assembly into a desired position adjacent the support assembly when the bottle assembly seats into the bottle seat assembly.

26. The mop of claim 25, wherein the plurality of support pockets comprises two support pockets positioned on opposite sides of a gap in the bottle assembly.

27. The mop of claim 25, wherein each support pocket of the plurality of support pockets defines a C-shaped cavity around the primary lobe.

28. The mop of claim 25, wherein the plurality of positioning protrusions comprises two positioning protrusions.

29. The mop of claim 25, wherein each support pocket further defines an outer wall that defines a portion of an edge of an attachment of the bottle assembly, the outer wall being shaped to follow a contour of a gap in the bottle assembly.

30. The mop of claim 25, wherein the wall structure of each bottle positioning protrusion defines a C-shaped configuration including a secondary wall and a tertiary wall connected by the primary wall, wherein the primary wall is longer than both the secondary wall and the tertiary wall, and wherein the secondary wall and tertiary wall extend in parallel offset by a length of the primary wall.
